(19) United States
(12) Patent Application Publication
(10) Pub. No.: US 2022/0263117 A1
(43) Pub. Date: Aug. 18, 2022

(54) Methods and Apparatus for a Charging Current Profile, a Charging Temperature Profile, and Spikes for a Rechargeable Battery

(71) Applicant: Atlis Motor Vehicles, Inc., Mesa, AZ (US)

(72) Inventors: Mark Hanchett, Mesa, AZ (US); Eric Anderson, Mesa, AZ (US); Archit Deshpande, Mesa, AZ (US); Abel Saucedo, Phoenix, AZ (US); Derek Duff, Bradley, ME (US)

(73) Assignee: Atlis Motor Vehicles, Inc., Mesa, AZ (US)

(21) Appl. No.: 17/217,516

(22) Filed: Mar. 30, 2021

Related U.S. Application Data
(60) Provisional application No. 63/003,186, filed on Mar. 31, 2020.
(60) Provisional application No. 63/144,589, filed on Feb. 2, 2021.

(51) Int. Cl. H01M 10/0525; H02J 7/00; H01M 10/44; B60L 53/62

(52) U.S. Cl. CPC H01M 10/0525; H02J 7/00716; B60L 2240/80; B60L 53/62; H01M 10/443

(57) ABSTRACT

A battery may be charged in accordance with a charging current profile and a charging thermal profile to increase the number of charge-discharge cycles the battery may perform, to reduce the effects of lithium plating on the performance of the battery, and to reduce the likelihood that dendrites will develop. Applying spikes in the charging current while charging in accordance with the charging profile further reduces the likelihood of developing dendrites.

### FIELD OF THE INVENTION

Embodiments of the present invention generally relate to a method for charging a rechargeable battery to lengthen the life of the battery.

### BACKGROUND

Rechargeable batteries theoretically may be recharged up to a maximum number of times; however, batteries may fail or have their performance degrade before the theoretically maximum number of charging cycles is reached. Methods and apparatus may be used to increase the number of recharge cycles of a battery, so that the number of recharge cycles is closer to the theoretical maximum while maintaining battery performance.

Further, methods for charging and using a rechargeable battery and the apparatus used to construct the battery may increase the performance and/or life of the battery.

### SUMMARY OF INVENTION

Methods and apparatus for rechargeable batteries are discussed to reduce the effects of electrical connections made of dissimilar metals and how to simplify the construction of rechargeable batteries. Simplified construction includes techniques such as electrically coupling the electrodes in parallel using a mechanical device. Further, methods for increasing the surface area of a solid electrolyte interface (“SEI”) layer that does not increase the thickness of the layer are disclosed. Methods are discussed for improving the evenness of the lithium plating on an SEI layer and to reduce the development of dendrites.

A charging current profile and a charging thermal profile are disclosed that increase the number of charge and discharge cycles a battery cell may perform. The charging profiles, both current and thermal, may also help to reduce the effects of lithium plating on an SEI layer and to reduce the development of dendrites on the SEI layer. While recharging a battery in accordance with the charging current profile, current spikes may be provided to further reduce the likelihood of, or even reverse, dendrite growth and development.

A battery pack as disclosed that includes a central control unit and a plurality of battery modules. The battery modules communicate with the center control unit in parallel. The battery modules communicate with each other in series. The battery modules include the battery cells. The battery modules and the central control unit may perform charge balancing. A battery pack may also include an environment container for controlling the temperature of the battery modules and/or battery cells.

Battery modules may be connected in series and/or in parallel to configure a battery pack to charge and discharge at a variety of voltages. A PCB may be used for electrically couple battery modules to the electronic and electromechanical devices of the battery pack.

Various methods for controlling the temperature of a battery pack, a battery module, and/or a battery cell are disclosed.

### BRIEF DESCRIPTION OF THE DRAWING

Embodiments of the present invention will be described with reference to the drawing, wherein like designations denote like elements, and:

FIG. 1 is a diagram of a rechargeable battery;

FIG. 2 is a perspective view of an electrode with an SEI layer;

FIG. 3 is a diagram of a rechargeable battery;

FIGS. 4-5 are diagrams of a rechargeable battery according to various aspects of the present disclosure;

FIG. 6 is a diagram of an electrode and SEI layer with lithium plating and dendrites;

FIG. 7 is a diagram of a charging current profile according to various aspects of the present disclosure;

FIG. 8 is a diagram of a charging thermal profile according to various aspects of the present disclosure;

FIG. 9 is a diagram of a charging current profile with current spikes according to various aspects of the present disclosure;

FIG. 10 is a diagram of a battery pack according to various aspects of the present disclosure;

FIG. 11 is a diagram of serial communication between battery modules;

FIG. 12 is a diagram of battery modules coupled in series;

FIG. 13 is a diagram of the PCB for electrically connecting battery modules;

FIG. 14 is a diagram of battery modules in a bath;

FIG. 15 is a diagram of a temperature management system;

FIG. 16 is a perspective view of a heatsink;

FIG. 17 is a front view of the heatsink of FIG. 16;

FIG. 18 is a top view of the heatsink of FIG. 16;

FIG. 19 a perspective view of a battery block;

FIG. 20 a top view of a battery block;

FIG. 21 a perspective view of a battery module formed from three battery blocks;

FIG. 22 a perspective view of the battery module of FIG. 22 with end pipes;

FIG. 23 a perspective view of the battery module of FIG. 22 with end pipes; and

FIG. 24 a perspective cutaway view of a battery module in a medium container.

### DESCRIPTION OF THE INVENTION

### Incorporation by Reference

Provisional patent application Nos. 63/003,186, filed Mar. 31, 2020 and 63/144,589, filed Feb. 2, 2021, both of which this application claims priority, are both incorporated herein by reference.

### Overview

A battery pack may be used to provide power to an electrical device, such as an electric vehicle. Battery packs may be configured to provide a current at a voltage. Standardized voltages for battery packs for electric vehicles include 200 V, 400 V, 800 V. A battery pack may deliver a current at a voltage as high as 1600 V. A battery pack may include one or more processing circuits, heaters, coolers, fans, pumps, valves, sensors, switches and communication circuits to perform the functions of the battery pack. A battery pack may further include a plurality of battery modules. A processing circuit of a battery pack may communicate with the battery modules of the plurality. A processing circuit of the battery pack may receive information from a battery module and/or send information to the battery module. Information may include a temperature of a battery cell and an amount of charge stored by the battery cell. A processing circuit of a battery pack may control in whole or in part the operation of a battery module.

Battery modules may be electrically connected in series and/or parallel to provide a current at the desired voltage. A battery module may include a plurality of battery cells. Battery modules may further include one or more processing circuits, switches, sensors and communication circuits.

A battery cell is the smallest unit of battery storage in a battery module and/or a battery pack. A battery cell includes anode and cathode terminals, anode and cathode electrodes, and a housing (e.g., case) that contains the electrodes and the electrolyte. A battery cell provides the current at a voltage. Battery cells may be electrically coupled in series and/or parallel to provide a current at the desired voltage.

The term battery may refer to a battery pack, a battery module, and/or a battery cell.

The number of times a battery (e.g., cell, module, pack) may be recharged may be increased by not recharging the battery to 100% capacity of the battery. The likelihood of a battery prematurely failing may be decreased by using a charging current profile in combination with a charging thermal profile. A charging profile and/or thermal profile may increase the life of the battery by decreasing dendrite development and improving lithium plating on the solid electrolyte interface (“SEI”) layer.

The temperature of the battery may be changed (e.g., increased, decreased) to increase the life of the battery. The temperature of the battery may be changed during recharge to facilitate recharge and to lengthen the life of the battery. Heating and/or cooling may be accomplished using thermal electric coolers and/or heated or cooled medium that transfer heat to and/or from the battery (e.g., battery cell, battery module”). A heated or cooled medium may include a liquid and or a gas. A cooling system may circulate two different media to cool a battery without permitting the media to intermix.

Balancing the charge accumulated between battery cells reduces stress on the battery cells during use and increases the life of the battery. Charge balancing may be accomplished via series connections between battery modules. Charge balancing may be accomplished by a series connection between adjacent battery modules during charge balancing.

The electrical connections between cells of the battery and circuits that control the operations of the battery may be formed in such a way to increase reliability and decrease the cost of assembling the battery. A PCB may be used to provide connections between the circuits that control a battery pack and the terminals of the battery modules and/or battery cells. A PCB may further provide structural strength to the battery pack. Further, the electrical connections between the cells in or modules of the battery may be configured to provide current at different voltages such as a standard specific voltage of 400 V, 800 V, and 1600 V.

### Electrode and Terminal Connections of Dissimilar Materials

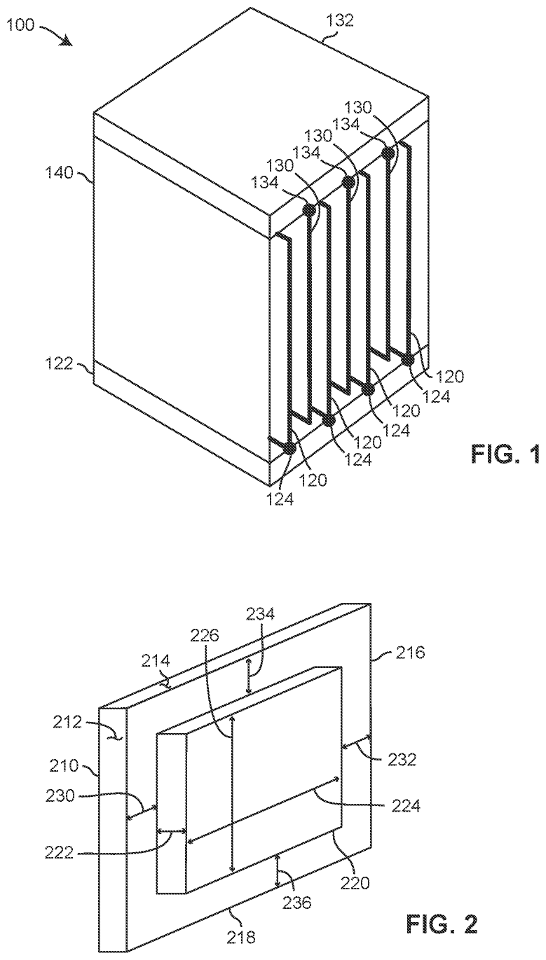

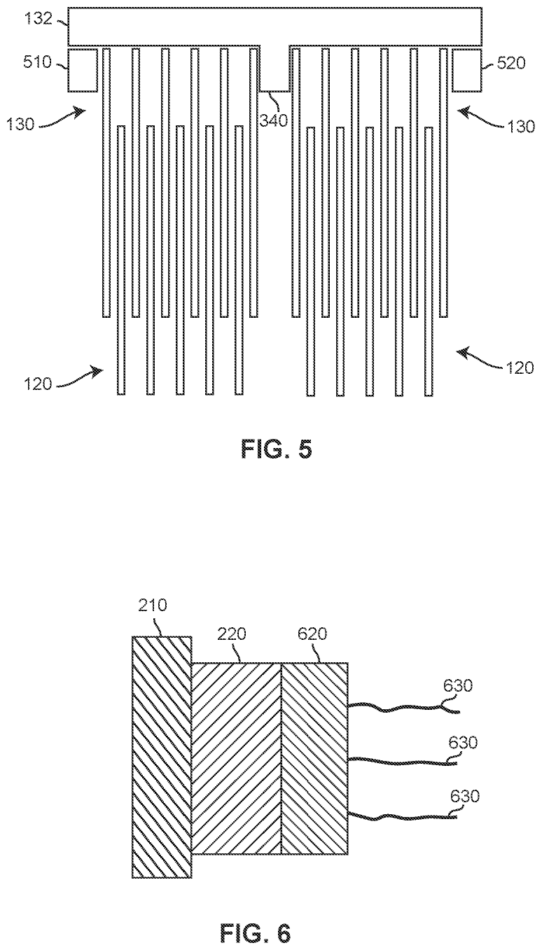

As discussed above, and as best shown in FIGS. 1-5, a battery cell generally includes terminals, electrodes, a housing, and an electrolyte. The housing contains (e.g., holds) the electrodes and the electrolyte. The terminals are positioned inside the housing. Charge flows out of the battery during use through the terminals. Charge flows into the battery during use through the terminals. The voltage of the battery cell is measured across the terminals. The voltage across the terminals of the battery is also an indication of the amount of charge held by the battery. The electrodes are arranged in the housing alternately as anode terminals and cathode terminals. The electrolyte (not shown in FIGS. 1 and 2, but shown in FIGS. 2 and 4) is positioned between the electrodes inside the housing. The electrolyte keeps the electrodes spaced away from each other so that an anode electrode does not touch and short out with a cathode electrode. Shorting out electrodes destroys the battery cell. The anode terminal mechanically and electrically couples to all anode electrodes. The cathode terminal mechanically and electrically couples to all cathode electrodes.

For example, each anode electrode 130 connects (e.g., in parallel) to the anode terminal 132 at the connection 134 respectively. Each cathode electrodes 120 connects (e.g., in parallel) to the cathode terminal 122 at the connection 124 respectively. The anode terminal 132 and the cathode terminal 122 may also be referred to as connectors, tabs, or bars (e.g., anode connector, cathode connector, anode tab, and so forth).

The connection 134 electrically and mechanically connects an anode electrode 130 to the anode terminal 132. The connection 124 electrically and mechanically connects a cathode electrode 120 to the cathode terminal 122. The connection 134 and the connection 124 may include one or more materials. As the current flows into or out of the anode terminal 132, the current flows through the material that comprises the anode terminal 132, through the material or materials that comprise the connection 134, and the material that comprises the anode electrode 130. If the connection 134 is formed of two different materials, the current possibly flows through four different materials: the material of the anode terminal 132, the first material of the connection 134, the second material of the connection 134, and the material of the anode electrode 130. The same applies for the cathode electrodes 120 and the cathode terminal 122.

For example, electrodes (e.g., anode, cathode) may be formed of aluminum. A copper strip may be coupled (e.g., ultrasonically welded) to each electrode. The terminals may be formed of aluminum. The copper strip connected to each anode electrode 130 may be coupled (e.g., welded) to the anode terminal 132, and the copper strip connected to each cathode electrode 120 may be coupled to the cathode terminal 122. In this example, the current that flows into or out of the battery cell 100 flows through three materials, two of which are the same; however, the current flows through two junctions where dissimilar materials meet.

Each location (e.g., interface, joint, connection) where dissimilar materials are coupled together generates heat, more heat than on each side of the coupling (e.g., weld joint), in response to a current flow. A sonically welded joint during the current flow (e.g., charge, discharge) may be up to 10° C.-20° C. hotter than the materials on each side of the weld joint or in the battery cell or module as a whole. The differences in heat generation and distribution creates fluctuations in the geometries (e.g., size) of the materials. Changes in geometries may cause heating and cooling issues. Fluctuations in geometries may also cause changes in electrical potential between two layers thereby inducing greater current flow in isolated areas of the battery which may result in heating issues, cooling issues, and/or current density issues. Changes in geometry may induce a more current to flow in the area where the geometry is changed and possibly increase the current flowing in the area to be greater than the current density that can be handled by the battery cell. The heating, cooling and current density issues created by dissimilar materials may result in a shortened battery life. However, the challenges of connections of dissimilar materials may be overcome by coupling electrodes to terminals mechanically rather than by welding as discussed below.

### Solid Electrolyte Interphase (“SEI”) Layer

As discussed above, an electrolyte is positioned between anode and cathode electrodes. The electrolyte enables the flow of electric charge between the cathode and the anode. A solid electrolyte interphase (“SEI”) layer may perform the functions of an electrolyte. An SEI layer may be formed of a solid material. An SEI layer may be formed of a gel. An SEI layer may be formed on an electrode so that an SEI layer is positioned between anode and cathode electrodes when the electrodes are placed in the battery cell housing. The SEI layer 220 shown in FIG. 2 is on the electrode 210. The electrode 210 represents an anode electrode 130 or a cathode electrode 120. What is not shown in FIG. 2 is a second electrode on the face of the SEI layer 220.

The material (e.g., cobalt based, silicon based, aluminum oxide based, iron phosphate based) that forms the SEI layer 220 is porous, so the surface area of the SEI layer 220 is determined not only by the width 224 and height 226 of the SEI layer 220 but also by its thickness 222. Increasing the surface area of the SEI layer 220 increases the amount of charge stored by the battery cell. However, increasing the surface area of the SEI layer 220 by increasing the thickness 222 of the SEI layer 220 results in fewer electrode fitting into the housing 140 of the battery cell 100 thereby resulting in lower energy density of the battery cell 100. Further, as SEI thickness 222 increases, it becomes more difficult to move energy into and out of the battery cell 100, so in general thinner SEI layers are preferred to thicker SEI layers. However, thinner SEI layers place the electrodes (e.g., 120, 130) closer to each other and increase the risk of damage due to dendrites (e.g., growth on an SEI layer). A dendrite, as best seen in FIG. 6, is a growth, in the case of the lithium battery of a narrow, spike-like growth of lithium metal, that forms as part of a film (e.g., the lithium plating 620) on the SEI layer 220. A dendrite 630 may grow to be long enough to contact and an adjacent electrode. An adjacent electrode is not shown in FIG. 6, but the adjacent electrode will be placed somewhere to the right of the dendrites 630. If the dendrite 630 grow long enough, they would reach the adjacent electrode and cause an electrical short between the electrode 210 and the adjacent electrode. An electrical short between electrodes may destroy a battery due to high current densities flowing through the short. The dendrite 630 does not have to grow very long to short between terminals when the SEI layer 220 is thin. So, a battery cell that uses thin SEI layers may benefit from a technique for reducing dendrite growth.

According to various aspects of the present disclosure, dendrite growth may be reduced by charging the battery according to a charging profile and a thermal profile discussed below. Charging the battery according to the charging profile and the thermal profile may also help to make the lithium plating 620 that forms on the SEI layer 220 as a battery is charged and discharged to be more uniform thereby reducing the likelihood of formation or growth of the dendrites 630. In other words, the charging profile (e.g., techniques) and/or the thermal profile decrease the difficulties associated with a thinner SEI layer 220 thereby reducing the risk associated with thinner SEI layers. Using the charging and temperature profiles, discussed below, while recharging a battery help overcome issues related to a thinner SEI layer. The charging profile helps to reduce dendrite formation, dissolve dendrites that have formed, facilitate even plating of the SEI layer 220 by the lithium plating 620, and increases the number of charge and discharge cycles the battery cell may perform. The thermal techniques, which include heating the battery during charging, help compensate for a thinner SEI layer by reducing the impedance of the battery cell 100 during charging which increases efficiency of charging and facilitating shorter charging times in cold climates.

With specific reference to FIG. 2, the SEI layer 220 couples to the electrode 210, which represents a cathode electrode 120 or an anode electrode 130. The SEI layer 220 covers the electrode 220 except for the spaces 230-236 on the sides of the SEI layer 220. The electrode 210 may be formed of copper or aluminum. The SEI layer 220 may be cobalt based, silicon based, aluminum oxide based, or iron phosphate based. The SEI layer 220 has the width 224, the height 226, and the thickness 222 identified in FIG. 2. Increasing with the width 224 or the height 226 increases the surface area of the SEI layer 220, but decreases energy density of the battery cell 100 and makes it more difficult to move energy into and out of the battery cell 100 as discussed above.

Decreasing, or minimizing, the thickness 222 of the SEI layer 220 facilitates placing a greater number of electrodes inside the housing 140 of the battery cell 100. As the thickness 222 of the SEI layer 220 decreases, the number of electrodes (e.g., 120, 130, 210) in the battery cell may increase, which results in the battery cell storing a higher energy density per battery cell volume.

The surface area of the SEI layer 220 may be increased by decreasing the space between the sides of the electrode 210 and the sides of the SEI layer 220. For example, the space 230, the space 232, the space 234 and the space 236 are the spaces between the side 212, the side 216, the top 214 and the bottom 218 of the electrode 210 respectively. Increasing the width 224 decreases the space 230 and the space 232 and brings the sides of the SEI layer 220 closer to the side 212 and the side 216 of the electrode 210. Increasing the height 226 decreases the space 234 and the space 236 and brings the top and bottom of the SEI layer 220 closer to the top 214 and the bottom 218 of the electrode 210. Increasing the height 226 and the width 224 of the SEI layer 220 increases the area and surface area of the SEI layer 220 thereby increasing the energy that may be stored in the battery cell 100. It is desirable to bring the edge of the SEI layer 220 as close to the edge of the electrode 210 as possible to maximize the area of the SEI layer 220.

However, maximizing the width and length of the SEI layer can introduce construction and assembly issues for a battery cell. As shown in FIG. 1, the top of the anode electrodes 130 connect to the anode terminal 132, while the bottom of the cathode electrodes 120 connect to the cathode terminal 122. The connection 134 limits how much the space 234 on the anode electrodes 130 may be reduced. In other words, the structure of the connection 134 limits how close the SEI layer 220 can get to the top 214 of the anode electrodes 130. The connection 124 limits how much the space 236 on the cathode electrodes 120 may be reduced because the structures of the connection 124 limits how close the SEI layer 220 can get to the bottom 218 of the cathode electrodes 120.

### Battery Cell Construction and Surface Area of the SEI Layer

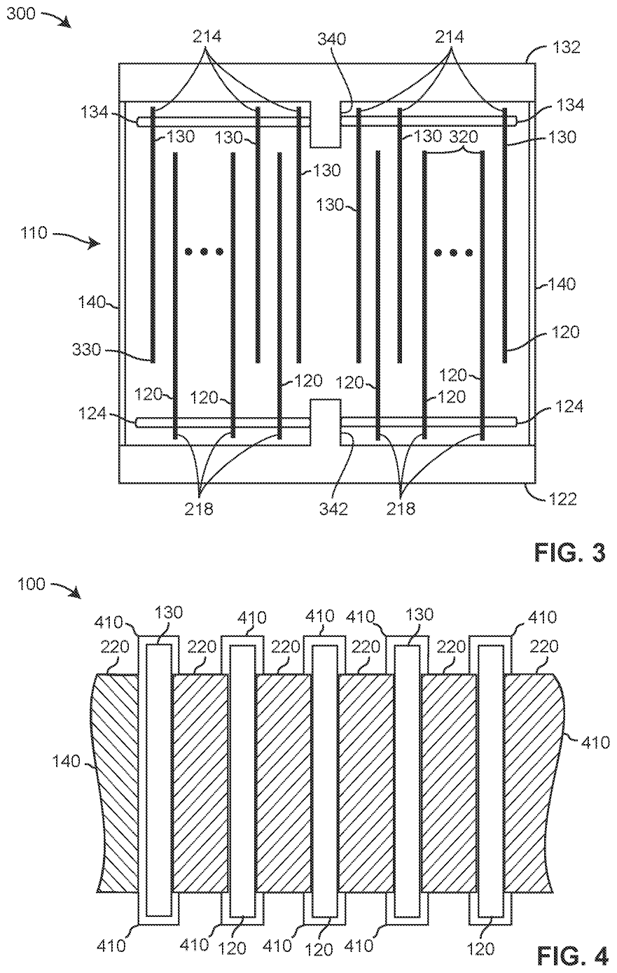

An example of the structure of the connection 134 and the connection 124 is shown in FIG. 3. The SEI layer between the anode electrodes 130 and the cathode electrodes 120 are not shown in FIG. 3. In FIG. 3, the anode terminal 132 is shown at the top of the figure and the cathode terminal 122 is shown at the bottom of the figure as in FIG. 1. The top 214 of the anode electrodes 130 are positioned proximate to the anode terminal 132 while the bottom 218 of the cathode electrodes 120 are positioned proximate to the cathode terminal 122.

When the first anode electrode 130 is positioned in the case (e.g., housing) 140, the top 214 of the anode electrode 130 is sonically welded to the post 340 of the anode terminal 132. Sonically welding the anode electrode 130 to the post 340 starts the formation of the connection 134. Welding the top 214 of the anode electrode 130 to the post 340 electrically and mechanically connects the anode electrode 130 to the anode terminal 132. When a next anode electrode 130 is positioned in the case 140, the top 214 of the next anode electrode 130 is sonically welded to the previously placed (e.g., adjacent) anode electrode 130 to continue the connection 134 from the post 340 through the previous anode electrode 130 to the next anode electrode 130. Successively welding the anode electrodes 130 to each other mechanically and electrically connects all of the anode electrodes 130 to each other, in parallel, and to the post 340. Inserting and welding the top of successive anode electrodes continues until all the anode electrodes 130 are positioned in the case 140 and sonically welded to adjacently positioned anode electrodes 130. Welding forms the connection 134 which electrically connects to the post 340 and to anode terminal 132 and the anode terminal 132 to each anode electrode 130. Because there may be hundreds of anode electrodes 130 in a single battery cell 100, assembly of the battery cell 100 may require hundreds of sonic welds to electrically connect the anode electrodes 130 to the anode terminal 132. A similar process is performed to couple (e.g., connect) the cathode electrodes 120 each other and to the post 342 of the cathode terminal 122 via the connection 124.

The above process of welding the anode electrodes 130 and the cathode electrodes 122 to the post 340 and the post 342 has been described to facilitate the describing how the connection 134 and the connection 124 are formed. In actual manufacture, the anode electrodes 130 and the cathode electrodes 120 would alternately be placed in the case 140 and welded so that the positions of the anode electrodes 130 and the cathode electrodes 120 will alternate in the case 140.

Because the space 234 between the top 214 on the anode electrodes 130 is blocked by the connection 134, it is difficult to entirely eliminate the space 234 on the anode electrodes 130 by extending the SEI layer 220 closer to the top 214 of the anode electrodes 130. Further, the space 236 between the bottom 218 on the cathode electrodes 120 is blocked due to the connection 124, so it is difficult to completely remove the space 236 on the cathode electrodes 120 by extending the SEI layer 220 closer to the bottom 218 of the cathode electrodes 120. So, the connections 134 and 124 limit the area and surface area of the SEI layer 220. The SEI layer 220 is extended as close as possible to the top 214 and the bottom 218 of the anode electrodes 130 and the cathode electrodes 120 respectively without interfering with the connection 134 or the connection 124 respectively. Extending the SEI layer 220 as close as possible to the edges of the electrodes increases the surface area of the SEI layer and the amount of charge stored.

Using a more accurate process (e.g., tighter tolerances) for manufacturing the case 140, the cathode electrodes 120 and the anode electrodes 130 may result in a more accurate positioning the cathode electrodes 120 and the anode electrodes 130 to have a more uniform and accurate space between them, positioning the connections 124 and 134 closer to the ends (e.g., the top 214, the bottom 218) of the electrodes, and decreasing the height of the posts 340 and 342. More accurate manufacturing could result in the decrease of the spaces 230-236 thereby increasing the area of the SEI layer 220.

To increase the accuracy of positioning the electrodes, the case 140 may include structures for positioning the electrodes. Any structure may be used to position, hold, and/or support electrodes to increase accuracy of positioning, increase the consistency of spacing, decrease the spacing between electrodes and facilitating connecting the electrodes to their respective terminals. In FIG. 4, a top cut-away view of a battery cell 300 that includes notches for positioning the electrodes. In FIG. 4, the anode terminal 132 was removed for viewing the internals of the battery cell 300. In this example, the notches 410 are used to position (e.g., hold) the anode electrode 130 and the cathode electrodes 120 which are alternately spaced. The notches for 10 may be implemented in any way suitable to hold and space the electrodes. The notches 410 may be grooves, as shown, that run the entire height of the case 140. Notches may be small protrusions (e.g., bumps) that extend the entire height of the case 140 or for only a portion of the height of the case 140. Notches and/or protrusions may be positioned on any side, top, or bottom of the case 140 to position the electrodes. The side of a notch and/or a protrusion may contact and/or support an electrode. The structure may correspond to the physical characteristics (e.g., thickness, height, position in the case 140, the position relative to the anode terminal 132 or the cathode terminal 122) of a particular electrode.

In this example, the anode terminal 132 has been cutaway, so the connection between the anode electrodes 130 and the anode terminal 132 is not shown. However, the structures that hold the terminals may also be used to either mechanically couple, as discussed below, the anode terminal 132 to each anode electrode 130 or, as discussed above, each anode electrode 130 may be welded to the anode terminal 132. As shown in FIG. 4, the notches for 10 allow the SEI layer 420 to cover the spaces 230 and 232 along with the sides 212 and 216. Using the notches 410, or another structure, aids increasing the surface area of the SEI layer 220 by increasing the width 224 of the SEI layer 220.

### A Mechanical Implementation for Connecting Electrodes to a Terminal

The efficiency of battery cell manufacture may be increased by reducing the number of sonic welds needed to mechanically and electrically couple the electrodes (e.g., anode, cathode) to the terminals (e.g., tab, bar, connector). In the example discussed above, each electrode is sonically welded to either a terminal, a post of the terminal, and/or a neighboring electrode. Sonic welding of electrodes may be eliminated by physically pressing (e.g., holding, squeezing, crimping) either the top or the bottom of the electrode against the terminal directly, against a post of the terminal, or against adjacent electrodes to establish an electrical and mechanical connection with the terminal.

For example, as best shown in FIG. 5, the tops of the anode electrodes 130 are pressed by the blocks 510 and 520 against the post 340. The force from the blocks 510 and 520 presses the anode electrodes 130 into physical contact with each other and with the post 340 to establish an electrical connection between the anode electrodes 130, the post 340 and the anode terminal 132. The impedance established between the anode electrodes 130 and the post 340 by blocks 510 and 520 may be the same or less than the impedance established by sonic welding. Any mechanical method (e.g., screw, bolt, clamp) may be used to move the blocks 510 and 520 against the anode electrodes 130 and into contact with the post 340. Any mechanical method may be used to hold blocks 510 and 520 against the anode electrodes 130 and the post 340. Once the blocks 510 and 520 are moved into a compressed position to compress the anode electrodes 130 against each other and to the post 340, the blocks 510 and 520 may be welded to the anode terminal 132 to keep the blocks 510 and 520 in place and the anode electrodes 130 mechanically and electrically coupled to each other and to the post 340. The blocks 510 and 520 may also be held in place by the mechanical structure used to move them into the compressed position, as opposed to welding them to the anode terminal 132. The physical and electrical coupling established by the blocks 510 and 520 with the post 340 of the anode terminal 132 and the anode electrodes 130 eliminates the need for sonic welding each anode electrode 130 and eliminates possibly hundreds of manufacturing steps associated with welding.

Any physical structure may be used to compress the top 214 of the anode electrodes 130 together to establish the physical and electrical coupling with the anode terminal 132. The sides of the case 140 of the battery cell may even hold the blocks 510 and 520 in the compressed position so that the anode electrodes 130 remain mechanically and electrically coupled to the anode terminal 132.

The cathode electrodes 120 (not shown in FIG. 5) may also be pressed against each other and against the cathode terminal 122 and/or post 322 using blocks or any other mechanical structure.

Using the blocks 510 and 520 to mechanically and electrically couple the anode electrodes 130 to the anode terminal 132 may eliminate connections between dissimilar materials and the issues related to connections of dissimilar materials as discussed above.

### Lithium Plating of SEI Layer and Dendrites

In lithium batteries, the SEI layer captures and releases lithium ions during charging and discharging of a battery cell. During charging, especially charging at a high rate (e.g., high current, fast time), the SEI layer tends to develop what is referred to as lithium plating. As best seen in FIG. 6, the SEI layer 220 is attached to the electrode 210. During charging, the lithium ions used to carry charge between the anode terminals 130 and the cathode terminals 120 have created the lithium plating 620 on the SEI layer 220. The lithium plating 620 is a layer of lithium metal that has been deposited on the SEI layer 220. Unfortunately, the lithium plating 620 decreases the charge capacity of the battery. The lithium plating 620 also increases the likelihood of generating dendrites 630 on the lithium plating 620. A dendrite 630 is a needle-like growth on the surface of the lithium plating 620. A dendrite 630 begins to grow when lithium ions begin to clump (e.g., nucleate) on the anode electrode 130. The length of the dendrite 630 may increase until the dendrite 630 contacts the cathode electrode 120 thereby causing a short between the anode electrode 130 and the cathode electrode 120. A direct connection between the anode electrode 130 and the cathode electrode 120 by a dendrite 630 causes the anode electrode 132 to electrically short out to the cathode electrode 120. The electrical short has a low impedance, so a high current may flow between the anode electrode 130 and the cathode electrode 120 through the dendrite 630. The high current flow can cause excessive heat in the battery cell. The growth of dendrites 630 that short out electrodes have been known to cause batteries to explode or catch on fire.

### Decreasing Lithium Plating and Dendrites

The growth and development of the lithium plating 620 and dendrites 630 may be counteracted or reduced by controlling (1) the current provided to the battery during charging (e.g., charging current profile); (2) the temperature of the battery during charging (e.g., charging thermal profile); and (3) introducing current spikes into the current provided to the battery during charging (e.g., charging spikes)). The amount of current provided to the battery over time is referred to as the charging current profile. The temperature of the battery may be managed in accordance with what is referred to as the charging thermal profile. Both the charging current profile in the charging thermal profile are discussed below. The nature of the spikes in the current provided to the battery during charging is referred to as charging spikes which are also discussed below.

### Charging Current Profile

A battery may store a maximum amount of charge (e.g., energy). The maximum amount of charge that may be stored by a battery is referred to as the capacity (e.g., storage capacity, charge capacity) of the battery. The storage capacity of the battery is measured in amp hours, which describes the number of amps a battery may provide for a specific number of hours. A battery that is charged to 100% of its charge capacity holds all of the energy it is capable of holding. In other words, a battery charged to 100% capacity holds (e.g., stores) its maximum amount of charge. A battery that is fully discharged holds zero charge. The voltage between the terminals of a fully charged battery is also at its maximum value. For example, for a fully charge lithium battery, the voltage between the anode terminal 132 and the cathode terminal 122 is 4.2 V. The amount of charge held by a battery may be determined by measuring the voltage between the anode terminal 132 and the cathode terminal 122. For lithium battery, if the voltage between the anode terminal 132 and the cathode terminal 122 is 4.2 V, the battery is fully charged and holds its maximum amount of charge. The voltage between the anode terminal 132 and the cathode terminal 122 of a fully discharged battery is 0 V.

The number of times that a battery may be charged then discharged (e.g., charge-discharge cycles) increases by not fully discharging the battery and not fully charging the battery. It is a general rule of thumb that the charge-discharge cycle count of a battery doubles for every 100 millivolts below the maximum charge voltage (e.g., 4.2 volts for a lithium battery) that the battery is charged. Charging a battery to only 90% of its total charge capacity does not charge the battery to its maximum charged voltage and therefore increases the battery cycle count.

During a charge-discharge cycle of the battery of the present disclosure, the battery is discharged until it holds about 10% of its charge capacity and charged to about 90% of its charge capacity. So, as the battery charges, the charge stored in the battery increases from the lowest point of 10% of its charge capacity to the highest point of 90% of its charge capacity. In time, after a number of charge-discharge cycles, the battery will be able to be charged to 95% of its charge capacity without reducing its maximum cycle count. Further, as the speed of charging the battery, which means the amount of time it takes to charge the battery, at the lower end increases, it may be possible to use a higher portion of the battery's capacity so that the battery may be charged to 95% of its total capacity. With these considerations, on-going cycle testing of the battery of the present disclosure shows that the battery may be charged to more than 90% capacity and still meet cycle count requirements.

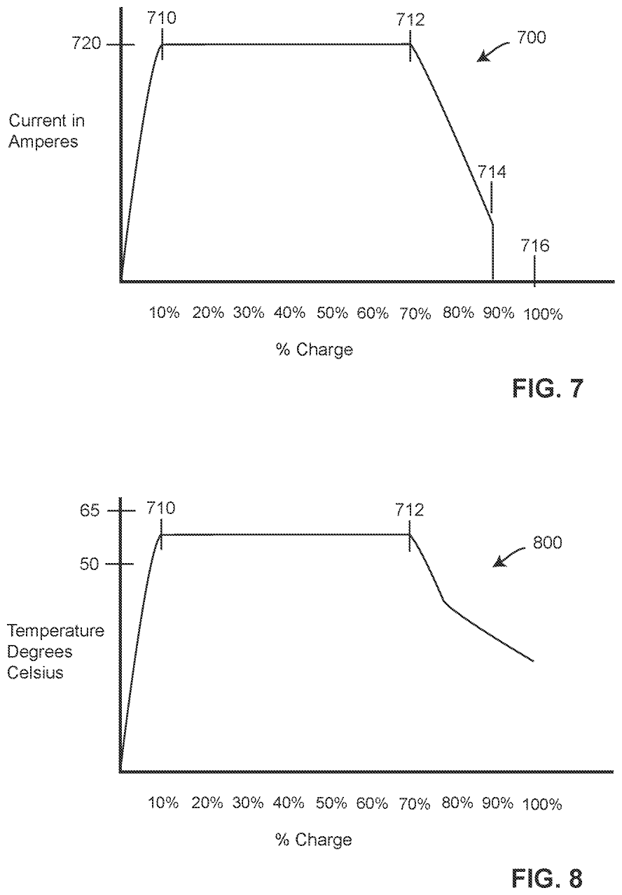

The diagram of FIG. 7 shows the current provided to charge a battery with respect to the percent of total charge capacity held by the battery to decrease lithium plating and dendrites. The current shown in FIG. 7 is referred to as charging current profile 700. As discussed above, at the start of charging the battery is charged 10% of its charge capacity. Charging ceases when the battery reaches 90% of its charge capacity.

The current used to charge a battery, referred to above as the charging current profile, is shown in FIG. 7 and is identified as charging current profile 700. The charging current profile 700 charges a battery that has been discharged from 10% of the battery capacity up to 90% of the battery capacity. So, the charging current profile 700 does not charge the battery to its maximum charge capacity, thereby increasing the number of charge-discharge cycles the battery may experience.

The charging current provided if the charging current profile 700 is used, quickly rises from zero at the beginning of recharging, maintains a constant high current, then tapers off the current until the battery is charged to 90% of its capacity. The amount of time during which the constant high current is provided begins at point 710 and lasts until to point 712. Point 710 marks when the battery is about 10% of its capacity. Point 712 is when the battery is between 60% and 70% of its capacity. The magnitude of the amount of current provided between the point 710 and the point 712, is referred to as the current 720. The amount of time that the current 720 is provided, the magnitude of the current 720, and the tapering of the current between the point 712 and the point 714 appears to be novel.

The magnitude of the current 720 is six times (e.g., 6×) the cell capacity. For example, for a battery (e.g., battery cell, battery module, battery pack) that has a charge capacity of 3 amp-hours (A h), the value of the current 720 would be 18 amps. The current 724 four a battery that has a 2,800 mA h capacity would be 16.8 amps.

Batteries provide a current at a particular voltage. Batteries generally need to be charged at the voltage that operates at. Some of the common voltages provided by batteries for electric vehicles include 200 volts, 400 volts and 800 volts. The battery of the present disclosure may operate at 200 volts, 400 volts, 800 volts, 1500 volts or 1600 volts. The battery may be configured to provide a current at any of these voltages, and a may also be charged at any of these voltages. The battery pack of the present disclosure may hold 250 kW hours of stored charge. So, if the batteries operating at 1600 V, it's capacity is 156.25 A h. If the battery is configured to operate at 1500 V, its capacity is 166.67 A h. At 800 V, its capacity is 312.5 A h, at 400 V, 625 A h, and 1250 A h at 200 V. While recharging the battery of the present disclosure, the recharger would provide 1.5 1\4W of power while providing the current 720 (e.g., 6*250 kW). So, if the battery is being charged at 1600 V, the value of the current 720 would be 937 A, at 1500 V the value of the current 720 would be 1000 A, at 800 V the value of the current 720 would be 1875 A, at 400 V the value of the current 720 would be 3750 A, and at 200 V the value of current 720 would be 7500 A.

The current 720 is provided to the battery until the stored charge reaches between 60% and 70% of the charge capacity. While the current 720 is provided, the battery stores a majority of its total charge capacity. If there is a linear relationship between the charge stored and time of charging, charging to 60% or 70% of the battery capacity means charging at the current 720 for 60% to 70% of the time needed for charging. For example, it takes five minutes to charge the battery to 90% of charge capacity, the current 720 is provided to the battery for between 3 and 3.5 minutes, which is a majority of the charge time.

The current provided by the charger between the point 712 (e.g., ˜70% charge) and point 714 (e.g., 90% charge) tapers off in accordance with the formula of Equation 1 below.:

I=(Vinput−Vcell)/Rcell Equation 1

Where:

Vinput: is the voltage at which the charger provides the current for charging (e.g., 200 V, 400 V, 800 V, 1500 V, 1600 V).

Vcell: the voltage between the anode terminal 130 and the cathode terminal 120 of the battery cell 100.

Rcell: if the internal resistance of the battery cell 100.

As a battery cell charges, the voltage between the anode terminal 130 and the cathode terminal 120, referred to as Vcell, increases because the amount of charge stored by the battery cell is increasing. As Vcell increases, it approaches the value of the voltage provided by the charger, Vinput. Because a battery cell has some internal resistance, Rcell, the current that enters the cell between the point 712 and the point 714 is governed by the above Equation 1, so the current provided by the charger begins to taper off as the voltage on the battery cell, Vcell, increases.

Since the battery is not charged to 100% of charge capacity to increase the number of charge-discharge cycles it can perform, as discussed above, charging stops at the point 114, which is when the battery is charged to 90% of its total charge capacity. Because charging is cut off when the battery reaches 90% of its total capacity, the current provided to the battery does not asymptotically approach 0 amps between the point 114 and the point 116 or beyond as occurs with most chargers. When the charging stops when the amount of charge stored by the battery reaches about 90% capacity, stops providing a current to the battery, so the current drops to zero.

Charging the battery cell at the high current 720 applies a high voltage across the SEI layer 220 during charging. The high voltage across the SEI layer 220 results in a high voltage per unit area across the SEI layer 220 that tends to cause even plating (e.g., depositing) of the lithium plating 620 over the SEI layer 220. Depositing the lithium plating 620 evenly over the SEI layer 220 reduces the likelihood that the dendrites 630 will develop. So, charging at a high current such as the magnitude of the current 720 helps to reduce the develop of the dendrites 630 and increases the lifetime of the battery.

### Charging Thermal Profile

Adjusting the temperature of the battery while charging, in accordance with the charging thermal profile, helps to reduce lithium plating of the SEI layer 220 and the development of the dendrites 630.

While the battery is being charged in accordance with the charging current profile 700, the temperature of the battery may be raised as shown in the charging thermal profile 800 of FIG. 8. While the magnitude of the charging current provided to the battery is the current 720, the temperature of the battery is raised to and/or maintain at between 50° C. and 65° C. Preferably, the temperature of the electrodes in the battery cells are raised to a temperature of between 50° C. and 65° C. In the event that a battery cell does not include sensors that detect the temperature of the electrodes in the battery cells, the temperature of a battery module or the battery pack may be raised to between 50° C. and 65° C. which may put the temperature of the electrodes closer to 75° C. and 80° C. Preferably, the temperature of the electrodes in the battery cell are raised or maintained in the range between 50° C. and 65° C. The temperature of the battery is raised to between 50° C. and 65° C. between the point 710 and the point 712, the temperature is raised and maintain while the battery is charged from 10% capacity to about 70% capacity. This mirrors the amount of time that the current 720 is provided to the battery. So, while the high current 720 is being provided to the battery, the temperature of the battery is also raised to between 50° C. and 65° C. Charging the battery while the battery is in the range of between 50° C. and 65° C. significantly reduces the likelihood of developing the dendrites 630.

As the magnitude of the current of the charging current profile 700 decreases between the point 712 and the point 714, the temperature of the battery may also be decreased. Once the battery is charged, which in this case is when the battery reaches a stored charge of 90% capacity, the temperature of the battery no longer needs to be held between 50° C. and 65° C. After charging, the battery may be allowed to cool to the ambient temperature depending on circumstances.

As the temperature of the battery decreases, and in particular if the temperature of the battery decreases to below 0° C., the likelihood of developing the dendrites 630 exponentially increases. Further, if the SEI layer 220 reaches 0° C. the likelihood of developing the dendrites 630 is high. So, while the battery is still being charged between the point 712 and the point 714, the battery of the temperature must be maintained above freezing and preferably in the temperature range 50° C. and 65° C. regardless of the ambient temperature. Further, if the battery is charged at any time while the vehicle is in operation (e.g., during regenerative braking), the battery must be operating in the temperature range of between 50° C. and 65° C. to reduce the likelihood of growing dendrites 630. So, if the battery is recharged while it is being used, the temperature of the battery should be maintained in the above range to reduce the likelihood of developing dendrites 630.

The battery of the present disclosure may have an overall charging time of around 15 minutes. During charging, the temperature of the battery must be raised and maintained at between 50° C. and 65° C. as discussed above. To meet the total charging time of 15 minutes, the temperature of the battery must be raised to between 50° C. and 65° C. in about one minute.

### Charging Spikes

The charging current profile 700 discloses providing the current 722 the battery while the battery charges from 10% of its capacity to about 70% of its capacity. It has been determined that applying spikes in the charging current may pull lithium off of the lithium plating 620, thereby reducing its thickness, or break off a dendrite 630, thereby reducing the likelihood of shorting between two electrodes. As discussed above, the lithium plating 620 decreases the charge capacity of the battery, so reducing the thickness of the lithium plating 620 increases the charge capacity of the battery. The lithium that is pulled off of the lithium plating 620 or the dendrite 630 that is broken off of the SEI layer 720 dissolves into the electrolyte and no longer interferes with the operation of the battery.

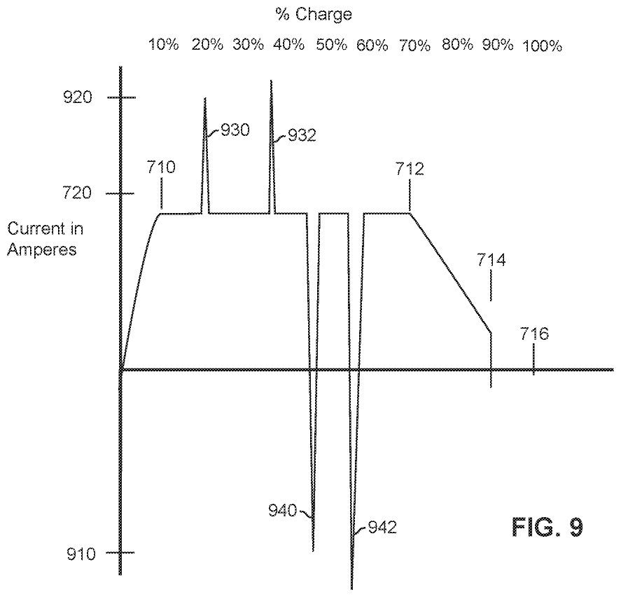

The current shown in FIG. 9 is the current of the charging current profile 700 with current spikes added to it. A current spike, temporarily increases, decreases or even reverses the current provided to the battery during charging. The current spikes 930 and 932 temporarily increase the amount of current provided to the battery during charging. The current spikes 934 and 936 temporarily decrease the current provided to the battery during charging. The current spikes 940 and 942 temporarily reverse the flow of the current to the battery to discharge the battery during the duration of the current spike. During the duration of the current spike 940 or 942, the charging station becomes a load to the battery such that the battery provides a current to the charging station. The current spike 940 or 942 may immediately follow the current spike 930 and/or 932.

The current spikes (e.g., 930, 932, 940, 942) may be provided at any time and in any number while the battery is being charged between the point 710 and the point 712 of the charging current profile 700. As discussed above, the current spikes may cause the dendrites 630 to break off of the SEI layer 220 or the layer of the lithium plating 620 to be decreased in thickness.

The current spikes are not very long in duration. However, the duration of a spike meets the threshold of providing between 10 mA h/cm\hat{ }2 (e.g., milliamp hours/centimeters squared) and 17 mA h/cm\hat{ }2, preferably at least 12 mA h/cm\hat{ }2, across the area of the SEI layer 220. A voltage across the SEI layer that is greater than this threshold tends to break the dendrites 630 off of the SEI layer 220 or off of the lithium plating 620.

The peak current of a current spike is preferably 10 times the capacity of the battery cell. For example, if the cell has 1 A h of capacity, the magnitude of the current 720 would be 6 A while, the magnitude of the current spike 930 or 932 would be 10 A and the magnitude of the current spikes 900 and 942 would also be 10 A but flowing in the opposite direction. The current 920 represents a current that is 10 times the capacity of the battery cell while the charger is providing the current into the battery. The peak current of the spike 930 and the spike 932 are equal to or greater than the current 920. The current 910 represents a current that is 10 times the capacity of the battery cell, but the battery is supplying the current instead of the charger supplying the current. During the current spikes 940 and 942, the charger acts as a load to the battery, so the battery provides the current. A positive current spike may immediately be followed by a negative current spike and vice versa. For example, the current spike 930 may be immediately followed by the current spike 940. Because the current spikes have a magnitude that is greater than 10 times the capacity of the battery, they apply the threshold force, or more, across the SEI layer 220 of between 10 mA h/cm\hat{ }2 and 17 mA h/cm\hat{ }2, preferably at least 12 mA h/cm\hat{ }2, across the area of the SEI layer 220 thereby thinning the lithium plating 620 and breaking off the dendrites 630. The width of a current spike is between 10 ms and 100 ms inclusive.

### Charging Current Profile, Charging Thermal Profile, and Charging Spikes

A method may be performed by a charging station for charging a battery. The method may aid in reducing the development of dendrites on a solid electrolyte interface layer of the battery. The method includes: providing a current at a first magnitude and a voltage, providing the current at a second magnitude and stopping providing the current. The current is provided at the first magnitude and the first voltage until an amount of charge stored by the battery is between 60% and 70% of the storage capacity of the battery. The first magnitude of the current is at least six times a storage capacity of the battery. After the amount of charge stored by the battery is at least one of 60% and 70% of the storage capacity of the battery, providing the current at a second magnitude. the second magnitude in accordance with an internal resistance of the battery and an output voltage of the battery. The second magnitude of the current may be equal to the current expressed in Equation 1 above. Stopping providing the current when the amount of the charge stored by the battery is 90% of the storage capacity of the battery.

Another method may be performed by a charging station for charging a battery. The method may aid in reducing the development of dendrites on a solid electrolyte interface layer of the battery. The method includes: providing a current at a first magnitude and a voltage, increasing the current to a second magnitude or reversing a direction of a flow of the current and increasing the current to the second magnitude and stopping providing the current. The current is provided at the first magnitude and the voltage until an amount of charge stored by the battery is between 60% and 70% of the storage capacity of the battery. The first magnitude of the current is at least six times a storage capacity of the battery. Increasing the current to a second magnitude or reversing a direction of a flow of the current and increasing the current to the second magnitude is done for a duration of time. While the direction of the flow of the current is reversed, the current flows out of the battery at the second magnitude. The second magnitude is at least 10 times the storage capacity of the battery. The duration of time is between 10 and 100 ms inclusive. The current is stopped when the amount of charge stored by the battery is 90% of the storage capacity of the battery.

Another method may be performed by a charging station for charging a battery. The method may aid in reducing the development of dendrites on a solid electrolyte interface layer of the battery. The method includes: providing a current at a first magnitude and a voltage, during a first duration of time, providing the current at a second magnitude and during a second duration of time, reversing a direction of the current to draw the current at a third magnitude from the battery. The first magnitude of the current is at least six times a storage capacity of the battery. The first magnitude of the current is at least six times a storage capacity of the battery. The second magnitude greater than the first magnitude. The current at the second magnitude provides between 10 mA h/cm\hat{ }2 and 17 mA h/cm\hat{ }2, preferably at least 12 mA h/cm\hat{ }2, across an area of the SEI layer in a first direction. The current at the third magnitude provides between 10 mA h/cm\hat{ }2 and 17 mA h/cm\hat{ }2, preferably at least 12 mA h/cm\hat{ }2, across the area of the SEI layer in a second direction. The second direction opposite the first direction. The first duration of time and the second duration of time are between 10 and 100 ms inclusive.

### Battery Control and Management

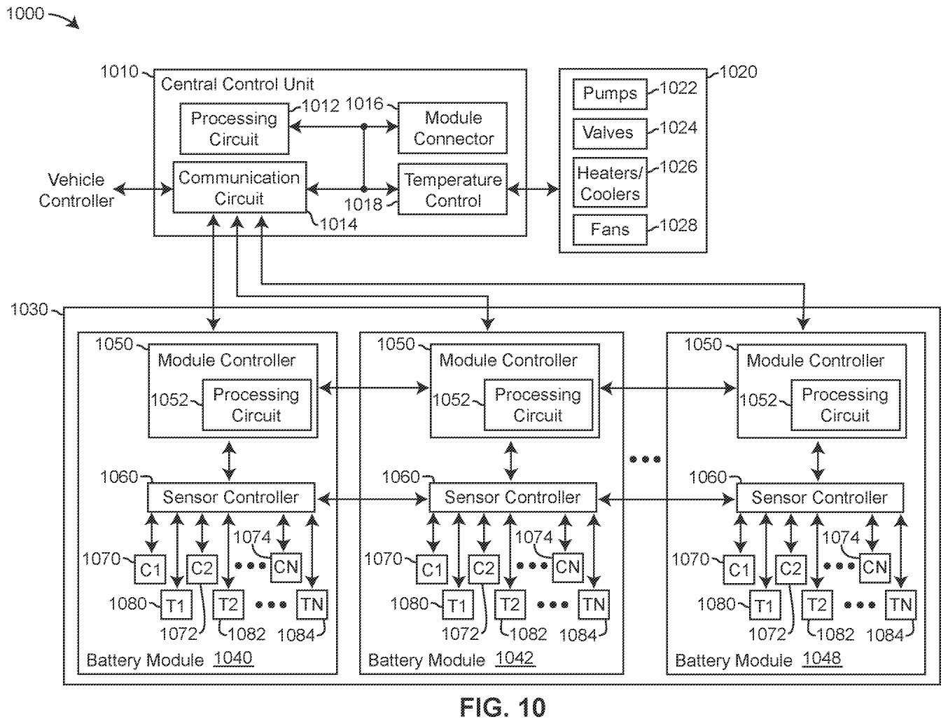

As briefly discussed above, a battery pack, as best shown in FIG. 10, provides current at a voltage to a device that needs electrical power. A battery pack 1000 may include a central control unit 1010, a thermal controller 1020, an environment container 1030, and a plurality of battery modules 1040-1048. The thermal controller 1020 may include heaters/coolers 1026, fans 1028, pumps 1022, valves 1024 and any other device for heating and cooling an object. A central control unit 1010 may include a processing circuit 1012, a communication circuits 1014, a module connector 1016, and a temperature control 1018. A battery module 1040, 1042, or 1048 may include a processing circuit 1052, a sensor controller 1060, a plurality of battery cells 1070-1074, and a plurality of thermocouples 1080-1084.

The central control unit 1010 may communicate with each battery module 1040-1048 of the plurality of battery modules. The central control unit 1010 may send information to and receive information from the battery modules 1040-1048. The central control unit 1010 may control the operation of the battery modules 1040-1048. The central control unit 1010 may control the operation the thermal controller 1020. The central control unit 1010 may receive information from one or more battery modules 1040-1048 and control the operation of the thermal controller 1020 in accordance with the information. The central control unit 1010 may receive information from one or more battery modules 1040-1048 and instruct and/or control one or more battery modules to 40—did 44 to balance the charge on the battery cells 1070-1074 of the one or more battery modules 1040-1048. The central control unit 1010 may instruct and/or control charge balancing between the battery cells 1070-1074 of the different battery modules 1040-1048.

The battery modules may communicate with each other. The processing circuit 1052 of a battery module 1040-1048 may receive information from the plurality of the battery cells 1070-1074 that comprise the module. The processing circuit 1052 of a battery module may control one or more switches in the sensor controller 1060 to provide charged to a battery cell 1070-1074, receive charge from a battery cell 1070-1074 and/or distribute charge between battery cells (e.g., balance charge) 1070-1074.

The battery modules 1040-1048 may be contained (e.g., confined, held) in an environment container 1030. The central control unit 1010 may control the temperature of the environment container 1030. In turn, the temperature of the environment container 1030 affects the temperature of the battery modules 1040-1048. For example, a central control unit may control the temperature of the environment container 1030 by increasing or decreasing the temperature of the temperature container 1030 and the battery modules 1040-1048 therein. The central control unit 1010 may control a rate of change of temperature of the environment container 1030.

The central control unit 1010 may control the connections between the terminals (e.g., anode terminal 132, cathode terminal 120, not shown in FIG. 10) of the battery modules 1040-1048 during charging and/or discharge of the battery pack. Controlling the connections of the terminals of the battery modules 1040-1048 enables connecting battery modules 1040-1048 in parallel or in series, so the battery pack 1000 provides the current at a specific voltage. For example, the central control unit 1010 may connect some of the battery modules 1040-1048 in parallel and others in series to provide a current at a voltage of 200 V, 400 V, and so forth. The central control unit 1010 may connect the battery modules 1040-1048 in series and parallel to receive a charging current at 200 volts, 400 V, and so forth.

The central control unit 1010 may communicate with the processing circuit of the vehicle controller that controls the systems of an electric vehicle.

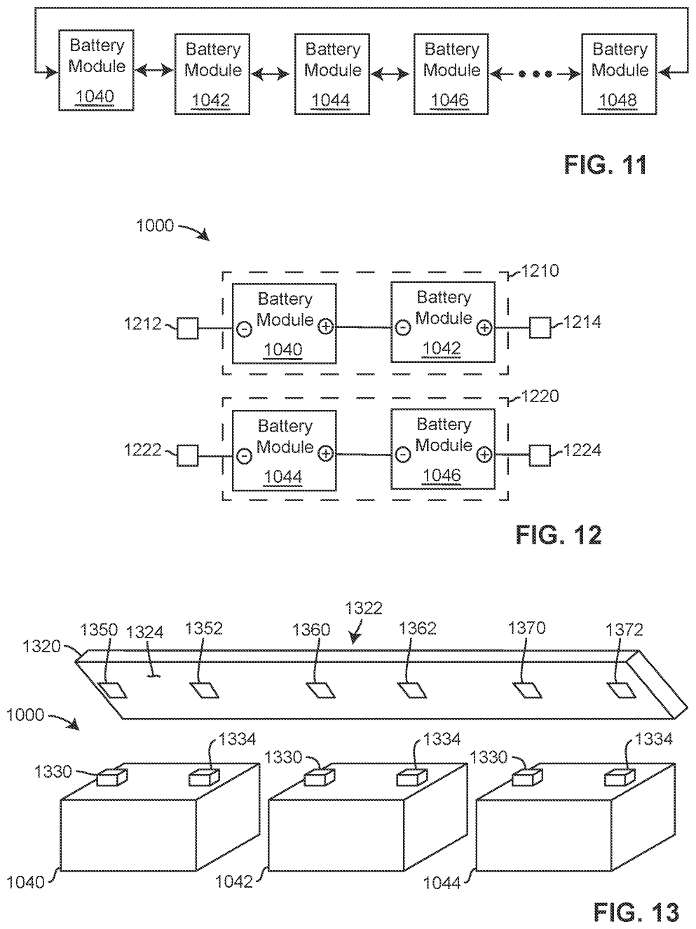

Although only three battery modules 1040, 1042 and 1048 are shown in FIG. 10, battery pack 1000 may include more than three battery modules shown in FIG. 10 or the five battery modules shown in FIG. 11.

In the battery pack 1000, the central control unit 1010 may communicate with the battery modules 1040-1048 in parallel. In an implementation, communication between the central control unit 1010 and the battery modules 1040-1048 is accomplished via ethernet connections.

In an implementation, the battery module 1040, the battery module 1042 and the battery module 1048 are coupled to each other in a series topology. In a series topology, communication between the battery module 1040, the battery module 1042 and the battery module 1048 is accomplished by serial communication. A series topology may also be arranged to be a ring topology or not a ring topology. In a series topology that is not a ring topology, the battery module at the beginning of the series (e.g., 1040) cannot directly communicate with the cell at the end of the series (e.g., 1048). All communication between the beginning battery module and the end battery module in the series must be accomplished communicating via all of the battery cells in the series. For example, if battery modules 1040, 1042 and 1048 were connected in a non-ring series topology, battery module 1040 would use series communication to communicate with battery module 1048 by sending and receiving information via battery module 1042.

A series topology that is arranged as a ring is shown in FIG. 11. The battery module 1040 is the beginning battery module in the series of the battery modules 1040, 1042, 1044, 1046 and 1048. In this topology, each battery module is coupled to its proximate neighbors in the series. Accordingly, the battery module 1040 couples to the battery module 1042 and the battery module 1048. The battery module 1042 couples to battery module 1040 and battery module 1044, and so forth. The series connection between the battery module 1040 and the battery module 1048 establishes the ring series topology. Communications between the battery modules 1040-1048 occur by series communication between adjacent neighbors.

The battery cells 1070-1074 of the modules 1040-1048 represent a plurality of battery cells. The battery cells 1070-1074 may operate in accordance with battery cells of the present disclosure. The thermocouples 1080-1084 detect and report the temperature of a battery cell, a plurality of battery cells, and or the battery module. Although a plurality of thermocouples 1080-1084 are represented, each module 1040-1048 may have a single thermocouple.

The sensor controller 1060 may detect the voltage of the battery cells 1070-1074, and thereby an amount of charge stored by a battery cell and the temperature sensed by thermocouples 1080-1084. The sensor controller may further couple any battery cell 1070-1074 to any other battery cell 1070-1074 or battery cells 1070-1074. In an implementation, sensor controller 1060 may connect one battery cell selected from battery cells 1070-1074 to any other one battery cell selected from battery cells 1070-1074. In another implementation, sensor controller 1060 may connect any number of battery cells 1070-1074 to any other number of battery cells 1070-1074.

### Charge Balancing of Charge Held on Battery Cells

As discussed above, each battery module 1040-1048 includes a plurality of battery cells 1070-1074. After being charged, the amount of charge held by each battery cell 1070-1074 of a module, and thus the voltage on each battery cell 1070-1074, may differ slightly. The module controller 1050 of a battery module 1040-1048 may detect the differences in charge between the battery cells 1070-1074 of the module by detecting the output voltage of each of the battery cells 1070-1074. The output voltage of a battery cell, as discussed above, is the voltage between the anode terminal and the cathode terminal. If there is a difference in the output voltage between two different battery cells 1070-1074, the amount of charge stored by the two different battery cells is not the same.

For example, due to differences that occur during charging, the output voltage of one battery cell (e.g., 1070) may be 4.1 volts while the output voltage of another cell (e.g., 1074) may have an output voltage of 4.0 volts. The module controller 1050 may balance the charge held by the two battery cells 1070 and 1074 so that the output voltages of each battery cell is the same (e.g., 4.05 volts). Balancing may be accomplished by coupling battery cell 1070 in parallel with battery cell 1074 each other so that the amount of charge on the two battery cells equalizes. The battery cell 1070 is connected in parallel to the battery cell 1074 by connecting the anode terminals of both battery cells to each other and the cathode terminals of both battery cells to each other.

When battery cells are connected in parallel, charge flows from the battery cell having the most amount of charge to the battery cell having the lesser amount of charge. As discussed above, the output voltage of a battery cell is an indicator of the amount of charge held by the battery cell. In this case, the battery cell 1070 has an output voltage of 4.1 V while the output voltage of the battery cell 1074 is only 4.0 volts. Since the battery cells 1070-1074 all have the same capacity, the battery cell 1070 holds more charge than the battery cell 1074 because its output voltage is higher. So, in this case, when the battery cell 1070 is connected in parallel with the battery cell 1074, charge flows from the battery cell 1070 into the battery cell 1074. While the battery cell 1070 is connected in parallel to the battery cell 1074, charge from the battery cell 1070 flows into the battery cell 1074 until the amount of charge on both battery cell 1070 and battery cell 1074 is about the same to within a threshold.

As charge is transferred from the battery cell with the higher output voltage to the battery cell with the lower output voltage, the output voltage on the higher output voltage cell decreases while the output voltage of the lower output voltage cell increases. In this case, as charge transfers from the battery cell 1070 to the battery cell 1074, the output voltage of the battery cell 1070 decreases in the output voltage of the battery cell 1074 increases. In time, the charge between the two cells is balanced (e.g., about the same) so that each battery cell holds the same amount of charge to within a threshold, and thereby each battery cell has the same output voltage.

Balancing may be accomplished by a module controller 1050. The module controller 1050 may detect the output voltage of each battery cell 1070-1074 and connect battery cells in parallel to transfer charge between the battery cells as needed to balance (e.g., make about equal) the charge on the battery cells as evidenced by their output voltages. Once balancing has been accomplished, the output voltages of the battery cells 1070-1074 should all be about the same.

For example, the module controller 1050 may receive battery cell voltage output values from the sensor controller 1060 for the battery cells 1070-1074. Processing circuit 1052 of module controller 1050 may compare the output voltages from the battery cells 1070-1074. Sensor controller 1060 includes one or more switches. The switches may connect any two battery cells in parallel with each other. For example, sensor controller 1060 may connect the battery cell 1072 to the battery cell 1074. The connection between the battery cells is a parallel connection, as discussed above. The processing circuit 1052 may instruct the sensor controller 1060 to connect battery cell 1072 two battery cell 1074 until the output voltage of the battery cells 1072-1074 are to within a threshold voltage amount of each other.

A threshold voltage amount for charge balancing may be a voltage difference between the battery cells or the battery modules in the range of 0 V to 500 mV, preferably 50 mV. Regardless of the number of battery cells in a battery module, the module controller 1050 may iteratively connect two battery cells to each other in parallel so that the amount of charge on the battery cells becomes equal so the output voltage of the battery cells is the same to within the threshold.

For example, sensor controller 1060 may detect the output voltage of all of the battery cells of the battery module (e.g., the battery cells 1070-1074) and report the output voltages to the module controller 1050. The example assumes that all of the battery cells of the battery module have the same capacity, so that the output voltages of the various battery cells may be compared to determine a relative amount of charge stored. The module controller may identify the battery cell with the highest output voltage and with the lowest output voltage. The module controller 1050 may instruct the sensor controller 106 to connect the battery cell with the highest output voltage and the lowest output voltage in parallel to each other to transfer charge between the two battery cells. Once the output voltage of these two cells is equal to within a threshold, the module controller 1050 may identify the next battery cell with the highest output voltage and the next battery cell with the lowest output voltage. The module controller 1050 may repeat (e.g., iterate) this process until all battery cells of the battery module have the same output voltage to within a threshold.

Any algorithm may be used to select the two battery cells that should be connected to each other for charge balancing. For example, finding the maximum output voltage and minimum output voltage among the battery cells as discussed above. In another example, the selection process may search for the battery cell output voltages having a median value for connection to battery cells whose output voltage is either higher or lower. Regardless of the selection algorithm, the module controller 1050 iteratively controls the connection of battery cells to each other until all of the output voltages of the battery cells are to within a threshold of each other.

Although connecting two battery cells at a time has been discussed, three or more battery cells may be connected to each other in parallel to accomplish charge balancing. In the implementation of the battery pack 1000 shown in FIG. 10, the module controller 1050 may instruct the sensor controller 1060 to electrically couple any two battery cells to balance the charge between the two battery cells. In another implementation, the sensor controller may be instructed to connect any number of battery cells selected from the battery cells of the battery module. In an implementation, the sensor controller may connect all batteries of the battery module to each other at the same time, so that charge balancing occurs between all battery cells of the battery module at the same time.

Just as a module controller may balance the charge on the battery cells of its module, module controllers of different modules may cooperate with each other to balance the charge on the battery cells of different modules. For example, battery pack 1000 may balance the charge on the battery cells of the battery module 1040 with the charge on battery cells of battery module 1042. The central control unit 1010 may instruct the battery modules 1040 to connect one of its battery cells 1070-1074 to one of the battery cells 1070-1074 of battery module 1042 to balance the charge between the selected battery cells.

The central control unit 1010 may receive information as to the output voltage of all battery cells of all modules. The central control unit 1010 may determine which battery cells of which modules should be connected to balance charge between the battery cells.

In an implementation, a battery module may connect anyone of its battery cells to any one battery cell of an adjacent battery module in the series topology. For example, and as best illustrated in FIGS. 10-11, the battery module 1042 may connect one of its battery cells to a battery cell in the battery module 1044 or 1040. The battery module 1042 cannot connect its battery cells to the battery cells of battery module 1046 and battery module 1048. The battery module 1044 may connect any of its battery cells to the battery cells of battery modules 1042 and 1046 but not to the battery cells of battery modules 1040 or 1048, and so forth. Accordingly, the central control unit 1010 may balance the charge on the battery cells of adjacent modules and may iterate to balance the charge on all cells of the battery pack 1000 so that the output voltage of each battery cell is within a threshold.

Because the battery modules are limited to balancing only with the adjacent battery modules in the series topology, the central control unit 1010 will need to iterate charge balancing to accomplish balancing between the battery cells of non-adjacent battery modules. Any selection process may be used to select the battery modules and the battery cells within a module for inter-module balancing. Balancing charge between the battery cells of non-adjacent battery modules may require passing charge to or removing charge from the battery cells of a battery modules in between the non-adjacent battery modules in a series topology.

Balancing the charge on the battery cells of a module and the battery cells of all modules of a battery pack protect the battery cells and connecting conductors from being overstressed. For example, prior to balancing, the processing circuit 1012 and/or the processing circuit 1052 may detect that one battery cell has an output voltage of 5 volts while another battery cell has output voltage of 3 volts. Preferably the voltage across both cells should be 4 volts. If the cells were to be connected in series during discharge without first being balanced, the output voltage would be 8 volts, which is equal to the total voltage of the output if each cell were 4 volts, so there does not appear to be a problem; however, in operation the battery cell charged to 5 volts would be overcharged and stressed during discharge while the battery cell charged to 3 volts would be under charged. In this example, balancing would transfer charge between two the battery cells so that the output voltage of each battery cell is about 4 volts. The damage done by unequal charge on the battery cells would be discovered during discharge if the battery cell that is charged to 5 volts were to be connected in parallel to the battery cell that is charged to 3 volts. Connecting battery cells that are very unbalanced, as demonstrated by large differences in their output voltages, causes a large current to flow between the battery cells possibly damaging either of the battery cells and/or the wires between the batteries. Balancing the charge on battery cells reduces over-voltage situations and the potential that a battery cell may be damaged. Balancing, as discussed above may also be accomplished between the battery modules, which can eliminate over-voltage problems of battery modules.

Inter-cell and inter-module balancing may be accomplished because the module controllers and the battery modules 1040-1048 cooperate to transfer charge from any battery cell to any other battery cell, or from any battery module to any other battery module. The central control unit 1010 may monitor and/or control, in whole or in part, the balancing process.

### More on Charge Balancing

Assume that the battery pack 1000 is to be used in an electric vehicle that requires 800 V output from its battery pack. Further, assume that each battery module 1040-1046 includes a sufficient number of battery cells so that each battery module may provide a current at 400 V. The central control unit 1010 may connect some battery modules in parallel and other battery modules in series to configure the battery pack 1000 as an 800 V battery pack. The central control unit 1010 may configure the series and parallel connections between the battery modules via the module connector 1016. The connections between the battery modules 1040-1046, shown in FIG. 12, connect the battery modules 1040 and 1042 in series (e.g., series module 1210), and the battery modules 1044 and 1046 in series (e.g., series module 1220), to configure two 800 V series modules that may be connected in parallel to operate as the 800 V battery pack needed for the electric vehicle.

The series module 1210 includes the battery module 1040 and the battery module 142 connected in series, while the series module 1220 includes the battery module 1044 and the battery module 1046 connected in series. The cathode terminal of the battery modules 1040 and 1044 are the cathode terminals 1212 and 1222 of the series modules 1210 and 1220 respectively. The anode terminal of the battery modules 1040 and 1044 are electrically connected to the cathode terminal of the battery modules 1042 and 1046 respectively to connect the battery module 1040 in series to the battery module 1042 and the battery module 1044 in series with the battery module 1046. The anode of the battery modules 1042 and 1046 are used as the anode terminals of the series modules 1210 and 1220 respectively. Because of the series connection between the battery modules in the series modules 1210 and 1220, the series modules 1210 and 1220 each provide a current at 800 volts. The series modules 1210 and 1220 may be connected in parallel to provide the current at 800 volts for the electric vehicle.

The series and parallel connections of the battery modules of FIG. 12 represent the various ways that the central control unit 1010 of the battery pack 1000 may configure the battery modules to provide a current at the desired voltage. The battery pack 1000 of the present disclosure may configure its battery modules to at 200 volts, 400 V, 800 V, 1500 V and 1600 V. The central control unit 1010 a configure the battery modules of the battery pack 1000 to charge at one voltage (e.g., 1600 V) and to discharge at another voltage (e.g., 400 V).

With respect to balancing the battery modules shown in FIG. 12, assume that after a charging cycle, the voltage output of battery modules 1040-1046 is 350 volts, 360 volts, 350 volts, and 340 volts respectively. The average of the voltage output of the battery modules 1040-1046 is 350 volts. Because of the voltage difference between the battery module 1040 and b the battery module 1042, when they are connected in series, a current may rush from the battery module 1042 into the battery module 1040 thereby stressing the battery modules and the wiring between the battery modules. Because of the voltage difference between the battery module 1044 and 1046, connecting them in series may cause a current to flow from the battery module 1044 into the battery module 1046. Prior to connecting the battery modules in series, the central control unit 1010 may perform inter-module balancing or instruct the battery modules to perform inter-module balancing. Inter-module balancing starts with balancing the charge on the battery cells within a battery module, then balancing the charge on the battery cells between the battery modules. The process is iterated within the battery modules and in between the battery modules until all the battery cells of all the modules hold about the same amount of charge, which means they have about the same output voltage, as each other to within a threshold.

After balancing, the output voltage on the battery modules 1040 and 1042 is 355 volts respectively to within a threshold and the voltage on the battery modules 1044 and 1046 is 345 volts respectively to within a threshold. Once the voltages across the battery modules 1040 and 1042 are the same to within a threshold, the battery modules 1040 and 1042 may be connected in series as shown in FIG. 12 thereby forming the series module 1210. The voltage across the series module 1210 is 710 V. Once the voltages across the battery modules 1044 and 1046 are the same to within a threshold, the battery modules 1044 and 1046 may be connected in series as shown in FIG. 12 thereby forming the series module 1220. The voltage across series modules 1220 is 690 V.

Before the series module 1210 can be connected in parallel with the series module 1220, the voltages between the series modules 1210 and 1220 need to be balanced. As discussed above, the voltage across the series module 1210 is 710 volts and the voltage across the series module 1220 is 690 volts. If the series modules 1210 and 1220 were to be connected in parallel without balancing, a large current would rush between the series modules 1210 and 1220 potentially damaging the battery cells, the connecting wires, and/or other components. The central control unit 1010 may control the balancing between the series module 1210 and 1220 or may instruct the module controllers 1050 of the battery modules 1040-1046 to perform the charge balancing.

Balancing is accomplished by moving charge from one battery cell, battery module, or series module to another battery cell, battery module, or series module until the voltage across the series modules is the same. In an implementation, as discussed above, charge balancing is accomplished between the battery cells of the battery modules that are adjacent in the series topology. The order and selection of the battery cells for balancing and a method of iteration may be accomplished in any manner.

The overall logic of balancing the charge between the battery cells requires that the battery cells, the battery modules, and/or the series modules not be connected to each other if a voltage difference exists. In other words, balancing is accomplished prior to establishing series and parallel connections of the battery modules. After balancing, when the voltage across the battery cells, the battery modules, or the series modules is the same to within a threshold, the battery cells, the battery modules, or the series modules may be connected. If the battery cells, the battery modules, or the series modules are already connected, balancing cannot be performed, except for as discussed below using current steering and monitoring during charging.

In the above example, the module controllers of the series module 1210 would cooperate with the module controllers of the series module 1220 until the voltage across each series module is 700 volts. Once the voltage across the series modules is the same to within a threshold, they may be connected in parallel to form a battery pack that provides a current at up to 800 volts, but in this case at 700 volts, the highest voltage to which the series modules 1210 and 1220 could be balanced.

Connecting the battery cells, the battery modules, or the series modules without first balancing can cause large currents to flow between the battery cells, the battery modules, and/or the series modules. The large currents may flow so quickly that there are current spikes that are large in magnitude and that can damage the battery cells of the battery pack.

The central control unit 1010 of a battery pack 1000, in cooperation with the module controllers 1050 of battery modules 1040-1048, balances the charge between the battery cells, the battery modules, the series modules and the series modules that are connected in parallel. The module controllers 1050 may balance charge between the battery cells 1070-1074 of the battery module. The module controllers 1050 of different battery modules may cooperate with each other to balance the charge on the battery cells between the battery modules. The central control unit 1010 and or the module controllers 1050 of battery modules that are to be connected in series or connected in parallel may cooperate with each other to balance the charge between the battery modules before being connected in series or in parallel. The module controllers may cooperate with the central control unit 1010 to report the status of balancing.

Use of a series resistor (e.g., a limiting resistor) to limit the current flowing to or from a battery cell may be used to reduce the magnitude of the currents that flow into or out of the battery cells to reduce the likelihood of destroying the battery cells, the battery modules, the series modules, the parallel modules, or the connecting conductors during charging, discharge, or charge balancing. For example, a series resistor may be placed between battery cells to reduce the amount of current that flows between the battery cells to a magnitude that is safe and non-destructive. However, the current provided by a charger during charging must also flow through the series resistors. So, during charging the series resistor may limit the charge that can flow into a battery cell, so series resistors may increase charging time. Further, a series resistor would produce heat during charging that may become excessive. The disadvantages of series resistors may be avoided if balancing is used to limit the magnitude of the current that flows when battery cells or battery modules are connected together. Using balancing, instead of limiting resistors, enables high charging currents such as the current 720 and also higher discharge currents. Eliminating limiting resistors also reduces heat generated during charging and decreases the charging time.

### Balancing During Charging

The rush of large currents between unbalanced battery cells, unbalanced battery modules, unbalanced series modules and/or unbalanced parallel modules may be limited and/or controlled using pulse width modulation (“PWM”) techniques; however, such techniques move current only in the microamp to milliamp range. Balancing the battery cells and the battery modules of the present disclosure requires balancing currents in a much higher range.

Balancing in accordance with the present disclosure moves current in the range of 10 amps—30 amps at a time to make the balancing process fast. In an implementation, balancing an entire battery pack is accomplished at a speed that a human cannot detect. For example, balancing all battery cells, all battery modules, all series modules and/or all parallel modules of a battery pack is accomplished in between 3 and 100 milliseconds.

Balancing may even be accomplished during charging. If one battery cell is charging faster than another battery cell, the current being provided to the faster charging cell may be diverted for a period of time until the other cells catch up. The current being provided to the faster charging battery cell may be diverted to the slower charging battery cells to help them catch up faster. Accordingly, monitoring the amount of charge on battery cells may be performed during charging. Balancing during charging may steer currents on the order of 10-30 amps between battery cells, battery modules, series modules and/or parallel modules.

### Charge Balancing and Battery Pack Maintenance

Balancing charge between battery cells, battery modules, series modules and/or parallel modules allows battery modules in older battery packs to be individually replaced rather than scrapping and an entire battery pack when only one battery module fails. In a battery pack that includes many modules, one battery module may fail while the other battery modules still operate.

In conventional battery systems, the entire battery pack must be replaced when only a single battery module fails because the charge time of battery cells and battery modules change over time and if only one battery cell is replaced, the new battery cell charges at a rate different than the older battery cells thereby interfering with the charging process. Balancing makes it possible to replace the failed battery module with a new battery module while leaving the older battery modules in place. During charging, balancing may shunt the charging current in accordance with the charging rate of the various battery cells. The processors (e.g., processing circuit 1012, module controllers 1050) may monitor which battery cells are charging faster than other battery cells and direct the charging current to the battery cells that are slower to charge. The battery cells that charge faster, such as the newer battery cell, would receive less current over time than the cells that charge slower, such as the older cells. Balancing accommodates for the differences in the battery cells that result from age, so that older battery cells, or battery modules, may be used with newer battery cells, or battery modules, in the same battery pack.

### Charging Standards, Output Voltage

A battery module, for example, battery modules 1040-1048, may operate at a nominal voltage of 360 volts or up to a voltage of 400 volts. The central control unit 1010, via the module connector 1016, may connect battery modules in series or parallel to provide a current at 400 volts (e.g., 360 volts nominal), 800 volts (720 volts nominal) and 1600 volts (e.g., 1440 volts nominal, 1500 volts preferred).

Combined Charging System (“CCS”) standard 1.0 is a standard for charging batteries that operate up to 400 volts. First generation electric vehicles generally conform to this standard. The battery pack 1000, that includes four, 400-volt battery modules, may conform to the CCS standard 1.0 by operating the battery modules 1040-1046 in parallel so that the maximum voltage provided is 400 volts.

CCS standard 2.0 is a standard for charging batteries that operate up to 1000 volts; however, typical implementations are for 800-volt systems, such as more recent electric vehicles. The battery pack 1000, that includes four, 400-volt battery modules, may conform to the CCS standard 2.0 for an 800-volt system by operating two battery modules in series and the resulting series batteries in parallel to produce 800 volts. For example, the battery modules 1040 and 1042 may be connected in series, and battery modules 1044 and 1046 may be connected in series as shown in FIG. 12 and as discussed above.

The battery pack 1000 may also be configured to provide a voltage of 1600 volts, 1500 volts nominally, by connecting battery modules 1040-1046 in series. The battery pack 1000 may provide 1000 amps at 1500 volts, which means that a battery pack so configured may provide 1.5 MWatts (e.g., 1,500,000 watts) of power.

Charging vs. Discharging Voltages

Charging may be accomplished at one voltage while doing discharge the current from the battery pack may be delivered at another voltage. For example, assume that the electric motors of a vehicle operate at 800 volts. The battery pack may be configured to provide current to the motors at 800 volts, but during charging, in order to speed up charging, the battery may be configured to be charged at 1600 V. In another example, the electric motors of a vehicle may operate at 1600 volts, but the battery pack must be charged by an 800-volt charger. The battery pack may be configured to provide current at 1600 volts and receive a charging current at 800 volts.

The battery pack may be configured to operate at the different voltages by configuring the series and parallel connections of the battery modules of the battery pack. As discussed above the central control unit 1010 may establish the series and parallel connections between the battery modules via the module connector 1016. Since the central control unit 1010 is aware of when the battery pack 1000 is being charged or when it is operating as a battery pack, the central control unit 1010 may configure the operation of the battery pack 1000 to provide a current at a first voltage during charging and at a second voltage during discharge.

Dynamic configuration of the voltage of the battery pack 1000 allows the battery pack 1000 to be backward compatible with any charging system. A battery pack may be configured to operate at a voltage that is consistent with a particular charging system then reconfigured to provide current at a different output voltage. For example, battery pack 1000 may be configured to receive a current at 400 volts while charging the battery modules 1040-1048. Once charging is complete, the battery pack 1000 may be reconfigured to provide a current at 1600 V to be consistent with the electrical operations of an electric vehicle. In operation, each battery module 1040-1048 is controlled by a module controller 1050. The central control unit 1010 may establish the series and/or parallel connections between the battery modules 1040-1048 via module connector 1016 to charge at one voltage and deliver a current at another voltage.

### Printed Circuit Boards for Communication and Connections

As shown in FIG. 10, the central controller unit 1010 communicates with the battery modules 1040-1044, and the sensor controller 1060 communicates with the battery cells 1070-1074. The central controller unit 1010, the module controller 1050 and the sensor controller 1060 may further steer the current to and from battery cells 1070-1074. A printed circuit board (“PCB”) may be used not only to interconnect the various components of the battery pack 1000, but also to connect to the battery cells and/or modules. A PCB that connects directly to the battery cells or battery modules may reduce wiring and increase reliability of operation of the battery pack 1000. The connections between the PCB and the battery cells and/or battery modules may correspond to the physical position of the battery cells and/or the battery modules with respect to each other.

In an implementation, referring to FIG. 13, the PCB 1320 provides the substrate and the interconnection for the electronic and/or electoral mechanical components of the battery pack 1000 and further provides terminals (e.g., 1350, 1352, 1360, 1362, 1370, 1372) for connecting to either battery cells and/or battery modules. The electronic and/or electoral mechanical components of the battery pack 1000 may be mounted on the PCB 1320. The top 1322 and/or the bottom 1324 of the PCB 1320 may also include terminals 1350, 1352, 1360, 1362, 1370 and 1372. The terminals 1350, 1352, 1360, 1362, 1370 and 1372 are positioned on the PCB 1320 so that when the PCB 1320 is brought proximate to battery cells 1040, 1042 and 1044, the anode terminal 1030 and the cathode terminal 1034 of the battery cells 1040, 1042 and 1044 come into physical contact with the terminals of the PCB 1320 to establish electrical connection between the control circuits (e.g., central control unit, module controller, sensor controller) and the battery cells and/or modules. The terminals on the PCB may be physically located to match the physical location of the anode and cathode terminals on the battery cells and or modules.

In FIG. 13, the battery modules 1040, 1042 and 1044 are positioned proximate to each other as they would be positioned in the battery pack 1000. When the PCB 1320 is brought into physical contact with battery modules 1040, 1042 and 1044, terminals 1350 and 1352, 1360 and 1362, and 1370 and 1372 are physically positioned to come into contact with the anode terminal 1330 and the cathode terminal 3034 of the battery modules 1040, 1042 and 1046 respectively. The terminals of the PCB 1320 may be positioned on the top 1322 and or the bottom 1324 of the PCB 1320, the PCB 1320 may also be used to contact battery module terminals when they are positioned on the bottom of the battery module.

In the situation where a battery module has one terminal (e.g., anode terminal) physically positioned on a top of the battery module and another terminal (e.g., cathode terminal) physically positioned on the bottom of the battery module, one PCB may be brought into contact with the terminals on the tops of the battery modules while another PCB may be brought into contact with the terminals on the bottoms of the battery modules. The PCB on the top of the battery modules may be interconnected (e.g., cable, wires) to the PCB on the bottom of the battery modules.

Terminals 1350, 1352, 1360, 1362, 1370 and 1372 may be used to provide current and/or control signals to and from the battery modules 1040, 1042 and 1044 respectively. A PCB may have any number of terminals for coming into contact with one or more battery cells and/or battery modules. Some terminals may be used to transfer charging and/or discharging current, while other terminals may be used to communicate control signals between the components of the battery pack. Having terminals of the PCB directly couple to the anode and cathode terminals of the battery cell and/or the battery module provides structural strength to the battery pack and reduces the likelihood that a conductor may be severed or fail.

### Wireless Communication

In some cases, it may be possible for the electronic and/or electoral mechanical components of the battery pack 1000 to communicate via wireless transmission. In some cases, it may be possible to replace wired connections and or connections via a PCB with wireless connections. For example, the battery modules 1040-1048 may be in close physical proximity such that a very short-range wireless communication link may be used to communicate between the battery modules. In such a situation, even near-field communication links and/or optical links may be used. A series topology between the battery modules may be preserved even with wireless communication between the battery modules.

Potentially, the module controller 1050 of the various battery modules, may wirelessly communicate with the central control unit 1010. In another implementation, the central control unit 1010 may wirelessly communicate with the thermal controller 1020.

Wireless communication may be accomplished using light, magnetism, and/or radio waves. Communication using the transmitting and receiving of light may be accomplished by aligning a transmitter with a receiver. Transmitters and receivers may be incorporated into the housing of a battery cell and or a battery module. Physical channels in the housing of a battery cell, a battery module in or a battery pack may be used to transmit beams of light between transmitters and receivers. Magnetism may be used for wireless communication between components that are relatively close physically. Any conventional wireless protocol (e.g., WiFi, Bluetooth, Bluetooth Low Energy, Zigbee, Z-Wave, 6LoWPAN, DigiMesh, RF) may be used to wirelessly communicate between components of a battery pack.

However, wireless communication may introduce other challenges. Wireless communications may be susceptible to interception, spoofing, or counterfeiting. A wireless communication protocol may need to include encryption, for data privacy, and authentication to verify the authenticity of a transmitter and/or a receiver. Another issue associated with wireless communication is jamming. A strong signal from a proximate system, whether or not with malicious intent, may interfere with the wireless communication channels in a battery pack and interrupt the operations of the processing circuit of the battery pack. Other security measures may also need to be used to protect the battery pack and the processors therein from hacking.

### Thermal Management, Thermal Environment and Liquid Medium

As discussed above, the temperature of the battery cells of a battery pack may be managed to improve charging and performance of the battery pack. Temperature management may use a medium to transfer heat to or remove heat from the battery cells and/or the battery modules. A medium may include a liquid and/or a gas.

In an implementation, the battery cells and/or the battery modules of the battery pack may be immersed in a liquid medium (e.g., water, oil, anti-freeze) for heating and cooling the battery cells and/or the battery modules. The liquid medium may be contained in an environment (e.g., environment container 1030, thermal environment). An environment may include a container capable of holding the battery modules and/or the battery cells and the liquid medium. A thermal management system that uses a liquid medium may further include a manifold. A manifold receives the liquid medium and provides (e.g., outputs) the medium so that the medium flows over (e.g., top to bottom, bottom to top, side to side) the battery cells and/or the battery modules. The manifold may also ensure that the liquid medium flows evenly around the battery cells and/or the battery modules.

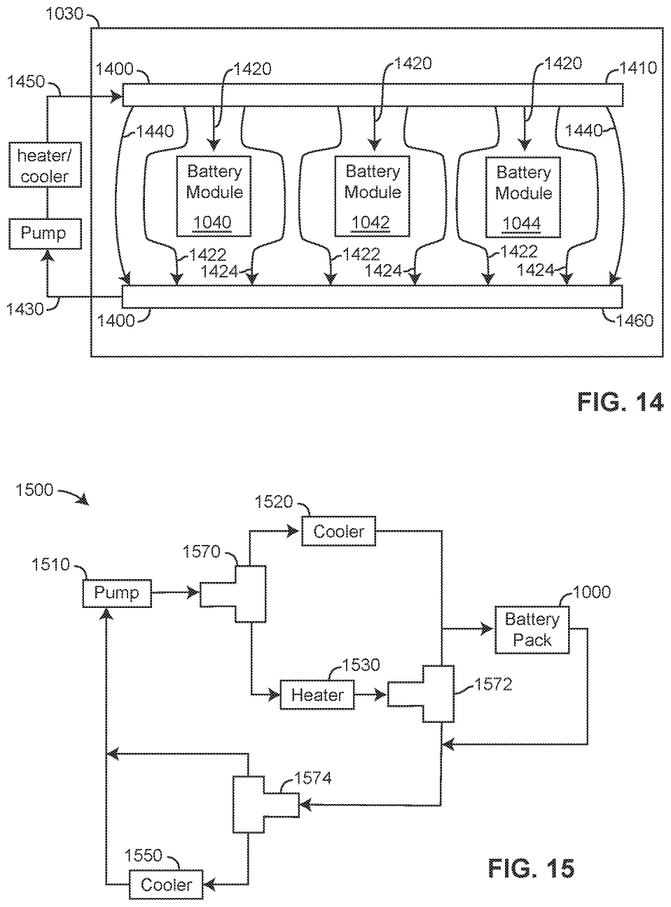

For example, as best shown in FIG. 14, the manifold 1400 may be used to provide a flow of liquid medium 1450 between and around the battery modules 1040, 1042 and 1044. The manifold 1400 may include a source manifold 1410 and a recovery manifold 1460. The source manifold 1410 receives the liquid medium 1450 from the heater/cooler. The source manifold 1410 provides the liquid medium 1450 to the battery modules 1440-1444 via the flows 1420, 1422, 1424 and 1440. The recovery manifold 1460 receives the flows 1420, 1422, 1424 and 1440. The recovery manifold 1460 consolidates f the lows 1420, 1422, 1424 and 1440 into the liquid medium 1430. The liquid medium 1450 or the liquid medium 1430 may be heated or cooled (e.g., heat exchanger, heater, refrigerator) to transfer heat to or remove heat from the battery modules 1040, 1042 and 1044.

The source manifold 1410 and the recovery manifold 1460 may include ducts, nozzles, and/or vents that direct the flow of the liquid medium around the environment container 1030 so that all sides, including top and bottom, of the battery modules 1040, 1042 and 1044 come into contact with the liquid medium. The ducts, nozzles, vents, or channels of source the manifold 1410 and the recovery manifold 1460 may further provide an even flow (e.g., 1440) between and around the battery modules 1040, 1042 and 1044.

The battery modules 1040, 1042 and 1044 may be immersed in the liquid medium and the manifold 1400 may direct the flow of the liquid medium through the pool of liquid medium to improve cooling and/or heating efficiency. The cooling and/or heating of one battery module may be independent of other battery modules.

In another implementation, the battery modules 1040, 1042 and 1044 are placed in a bath of the liquid medium that is contained by environment container 1030 and manifold 1400 controls the flow between and around the battery modules 1040, 1042 and 1044 to accomplish heat transfer, preferably even, to and from each battery module. Placing the battery modules in the bath eliminates hoses on the outside of the bath. All components necessary for circulating the liquid medium (e.g., pumps, manifold) or to heat or cool the liquid medium may be placed in the bath and/or in the liquid medium. The environmental container 1030 may be sealed to provide a battery pack that operates as a closed system.

The manifold 1400 may be integrated into the environment container 1030 that forms the bath in which the battery cells and the liquid medium are held.

### Resistive Coil and Rate of Temperature Change

A resistive coil may be thermally and/or mechanically coupled to the anode terminal and/or the cathode terminal of a battery cell to directly heat the battery cell. The anode terminal and the cathode terminal may be formed of an electrically and a thermally conductive material (e.g., metal). A resistive coil may heat the battery cell, but other means (e.g., fluid medium, TEC) may need to be used to cool the battery cell. However, using a resistive coil attached to the anode or the cathode terminal of each battery cell enables each battery cell to be heated independently of all other battery cells. The temperature of each battery cell or various physical locations in the bath held in the environment container 1030 may be monitored. Monitoring may identify battery cells or locations in the bath that are different in temperature (e.g., cooler, hotter) than other locations. The resistive coils of selected batteries may be selectively operated to even out the temperature of the battery cells and/or the liquid medium in the bath.

The battery (e.g., battery pack, battery modules, battery cells) of the present disclosure may have an overall charging time of around 15 minutes. During charging, as discussed above, the temperature of the battery may be raised and maintained to between 50° C. and 65° C. To meet the total charging time of 15 minutes, the temperature of the battery may be raised to between 50° C. and 65° C. in about one minute. The method used to heat the battery, whether TEC, resistive coil, or liquid medium in a bath, raises the temperature of the plurality battery cells and/or battery modules to between 50° C. and 65° C. in about one minute.

### Temperature Management System

The temperature management system 1500 uses a liquid medium to increase (e.g., heat) or decrease (e.g., cool) the temperature of the battery pack 1000. Pump 1510 receives the liquid medium at its input and provides the liquid medium at a pressure and a rate of flow at its output. Valve 1570 steers the liquid medium provided by the pump 1510 through heater 1530 or cooler 1520 before it reaches the battery pack 1000. To reduce the temperature of the battery pack 1000, the liquid medium from the pump 1510 flows through the valve 1570, into the cooler 1520, out the cooler 1520, into the battery pack 1000, out of the battery pack 1000, into the valve 1574, out of the valve 1574 and into pump 1510. To increase the temperature of the battery pack 1000, the liquid medium from the pump 1510 flows through the valve 1570, and into the heater 1530, out the heater 1530, into the valve 1572, out the valve 1572, into the battery pack 1000, out of the battery pack 1000, into the valve 1574, out the valve 1574 and into the pump 1510.

As discussed above, all of the components of temperature management system 1500 may be integrated into the battery pack 1000, so that most or all of the components of the temperature management system 1500 are internal to the battery pack 1000 and not external. For example, placing the battery cells in a bath (e.g., environment container 1030) as discussed above. The housing of the battery pack 1000 may perform the functions of the environment container 1030 to hold the liquid medium of the bath. The housing of the battery pack 1000 may hold the pump 1510, the cooler 1520, the heater 1530, the cooler 1550, the valve 1570, the valve 1572, and the valve 1574 in the bath of the liquid medium. The components may be integrated into the housing of the battery pack 1000 or may be placed inside the housing of the battery pack 1000.

The path through the cooler 1550 is used for testing purposes and likely would not be included in a production version of the temperature management system 1500.

The pumps, heaters, coolers, and valves of the temperature management system 1500 may be controlled by the central control unit 1010 via the thermal controller 1020. The central control unit 1010 in cooperation with the module controllers 1050 and the sensor controllers 1060 may monitor the temperature of the battery cells, the environment inside a battery cell, the housing of a battery cell, the environment surrounding the battery cells, the environment inside a battery module, the housing of a battery module, the environment surrounding a battery module (e.g., the bath in environment container 1030), and/or any location in or around the battery pack 1000. Responsive to temperature monitoring by the central control unit 1010 and the module controllers 1050, the central control unit 1010 may instruct the thermal controller 1020 via the temperature control 1018 to heat or cool a battery cell, a plurality of battery cells, a battery module, and/or a plurality of battery modules. In an implementation thermal controller controls the temperature of a liquid medium that is contained in environment container 1030.

### Thermoelectric Cooler (“TEC”)

Heat may further be transferred to and/or removed from a battery cell and/or a battery module using a thermoelectric cooler (“TEC”). A TEC is a solid-state heat pump that transfers heat from one side of the device to the other side of the device. The side of the TEC that is hot or cold depends on the direction in which the current is flowing through the device. A TEC may be used for heating or cooling an object.

A TEC operates in accordance with the Peltier effect, which is also more commonly known as the thermoelectric effect. A TEC includes a thermocouple. A thermocouple is an electrical device that includes electrical conductors of dissimilar materials that form an electrical junction. A thermocouple may produce a temperature-dependent voltage as a result of the thermoelectric effect; however, when a thermocouple is actively driven by a current, one side of the TEC gives off heat while the other side absorbs heat. When the current is reversed, the side that was giving off heat absorbs heat and the side that was absorbing heat now gives off heat.

A TEC may be thermally, and mechanically, coupled to any structure in a battery pack to provide heat to and/or remove heat from the structure. For example, a TEC may be thermally couple to a terminal (e.g., cathode, anode) of a battery cell and/or a battery pack. A TEC may be thermally coupled to a housing of a battery cell and/or a battery module. A TEC may be thermally coupled to a container that establishes an environment (e.g., environment container 1030) into which the battery cells and battery modules are placed for thermal management.

The current flow through a TEC may be controlled by the module controller 1050 and/or the central control unit 1010. The module controllers 1050 and/or the central control unit 1010 may receive temperature information (see e.g., temperature, rate of temperature change) from thermocouples positioned throughout the battery cells, the battery modules and/or the battery pack. Responsive to the thermal information, the module controller 1050 and/or the central control unit 1010 may control a TEC to heat or cool an area and/or an object. A medium may flow over a TEC to aid in heat transfer. For example, a battery module or a battery pack may use a fan to blow air over the terminals of the battery cells and the TECs thermally coupled thereto to help transfer heat to the battery cells or heat removal from the battery cells.

For example, assume that the first side of a TEC is thermally and mechanically coupled to an anode terminal of a battery cell. A current may be provided to TEC so that the first side of the TEC is cooler than the second side of the TEC, so the TEC cools the battery cell. Air may be blown over the battery cell to dissipate the heat produced by the second side of the TEC thereby increasing the efficiency of heat transfer from the battery cell via the TEC.

If the current provided to the TEC is reversed, the first side becomes hotter than the second side, so heat is transferred to the battery cell. Air may be blown over the battery cell to make the heat transfer of the second side more efficient. A heat sink may also be attached to the second side to more efficiently disperse the cooler temperature of the second side.

Experiments have shown that a TEC may heat or cool a battery cell quickly. Further, TECs are reliable because they have few moving parts thereby making them useful in a battery application. Using TECs to heat or cool battery cells would eliminate fluid medium heating and cooling systems and the complexities associated therewith. Using TECs could replace a fluid system with fans for blowing ambient air over the battery cells. However, in another implementation, TECs may be combined with a fluid medium heating and cooling system. Using TECs may enable the temperature of battery cells to be individually controlled. A TEC is capable of precisely controlling the temperature of a battery cell.

As discussed above, when a current is not driving a TEC, for example during the discharge cycle, the TEC produces a current. Each time a TEC is not driven by a current, the current produced by the TEC may be used to determine the temperature of the battery cells in the system.

### Heat Sink for Thermal Management

A battery (e.g., pack, module, cell) may include structures to aid in the transfer of heat to or from the battery and to or from one or more media (e.g., liquid, gas). Structures may be physically and/or thermally coupled to a battery to receive heat from or transfer heat to the battery. For example, a battery may include a heat sink. A heat sink may physically and thermally coupled to a battery (e.g., housing, container, package) to receive heat (e.g., transfer heat away) from the battery or to provide heat (e.g., transfer heat) to the battery. A heat sink may be formed of any material capable of heat transfer. Preferably, a heat sink is formed of metal (e.g., aluminum, copper). A heat sink may include any structure used in a conventional heat sink to facilitate the transfer of heat to or from the battery and to or from a medium. A heat sink may use structures to increase its surface area to increase a rate of heat transfer between the battery and the medium. For example, a heat sink may include fins (e.g., thin portions of the heat sink). A medium may come into physical and/or thermal contact with the battery and/or the heat sink of the battery to transfer heat to or from the battery.

A heat sink may be passive or dynamic. A passive heat sink transfers heat between the battery and the medium without the use of any active components (e.g., fans, pumps). The medium may move (e.g., circulate) in response to the heat transfer, but the medium is not moved around the heat sink and/or battery by a force other than heat transfer. An active heat sink uses active components to facilitate the transfer of heat between the heat sink and/or the battery and the medium. Active components may include fans and/or pumps. Active components may further include some form of heating and cooling. For example, fans may be used to circulate a gaseous medium around a battery and/or a heat sink to increase the rate of heat transfer. Pumps may be used to circulate a liquid medium around a battery and/or a heat sink. Some form of cooling (e.g., radiator, refrigeration) may be used to lower the temperature of the medium prior to circulation around the battery and/or the heat sink. Cooling the medium removes heat from the medium to increase the amount of heat the medium may transfer from the battery and/or heat sink.

A heat sink may include one or more channels (e.g., tubes, pipes, passages) through which a medium may flow to bring the medium into physical and/or thermal contact with the heat sink. Physical and/or thermal contact of the medium with the heat sink transfers heat from the heat sink to the medium or vice versa. A medium may move through a channel responsive to movement caused by thermal eddies. A medium may move through a channel responsive to a force (e.g., fan, pump). In an implementation, a single medium flows through the channels of a heat sink to transfer heat away from a battery or to transfer heat to the battery. In another implementation, two different media are used to transfer heat away from or to the battery. Some channels may carry a first medium while other channels carry a second medium so that the medium does not mix with each other. For example, some channels of a heat sink may carry a gaseous medium while other channels may carry a liquid medium. The channels that carry the different media do not intersect, so the different medium does not intermix.

A heat sink may be configured to be in physical and/or thermal contact with a body (e.g., can, housing) and/or a terminal of a battery. A thermal paste may be used between the heat sink and the body or the terminal of the battery. The thermal paste may decrease thermal resistance between the battery and the heat sink thereby increasing the transfer of heat between the battery to the heat sink. The heat generated by the battery increases the temperature of the body of the battery. The heat transfers from the body of the battery to the heat sink and from the heat sink to the medium thereby decreasing the temperature of the battery. Heat carried by the medium may increase the temperature of the heatsink which in turn transfers heat to the body of the battery thereby increasing the temperature of the battery. The

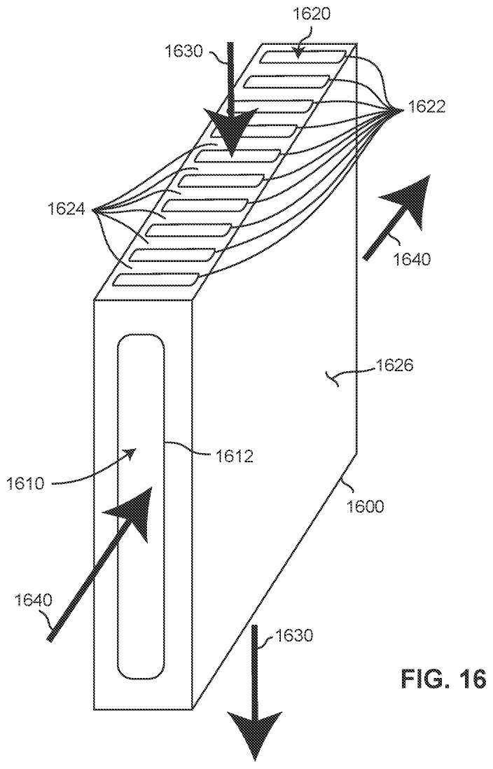

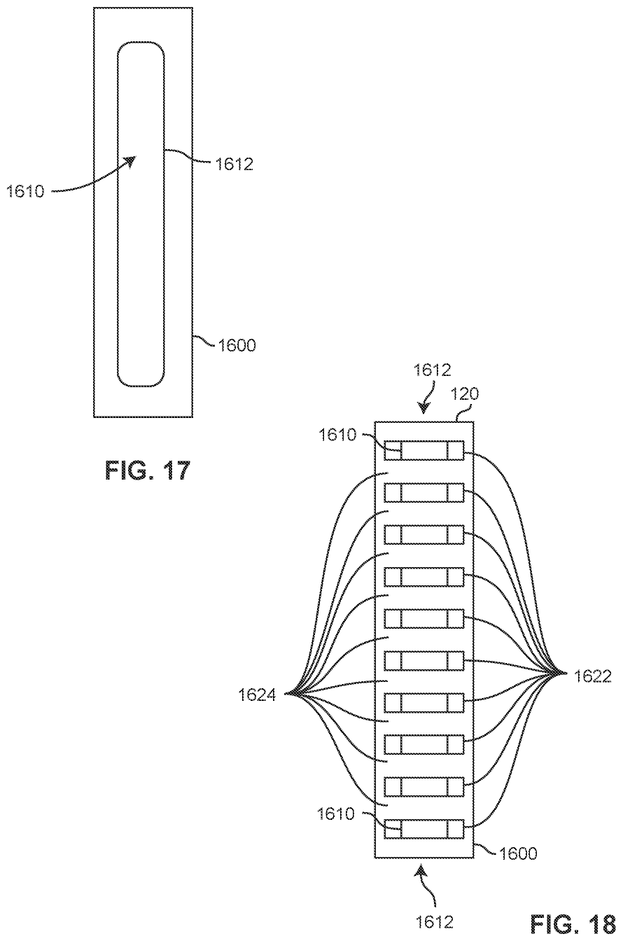

In an implementation, referring to FIGS. 16-18, the heat sink 1600 includes a pipe 1610 with an opening 1612, a passage 1620 with openings 1622, fins 1624 and sides 1626. The pipe 1610 is separate from the passage 1620, so the medium 1630 flows through the passage 1620 between the sides 1626 without mixing with the medium 1640 which flows through the pipe 1610. Multiple heat sinks 1600 may be stacked one on top of the other, with respect to FIG. 16, to lengthen the passage 1620. The interface between heatsinks that are stacked on top of each other may be sealed to contain the flow of the medium 1630 in the passage 1620 without escaping through the interfaces between heatsinks 1600.

Multiple heatsinks may be placed end-to-end, with respect to FIG. 16, to lengthen the pipe 1610. The interface between the heat sinks 1600 that are positioned end-to-end may be sealed to contain the flow of the medium 1640 through the pipe 1610 without escaping through the interfaces between the heatsinks 1600.

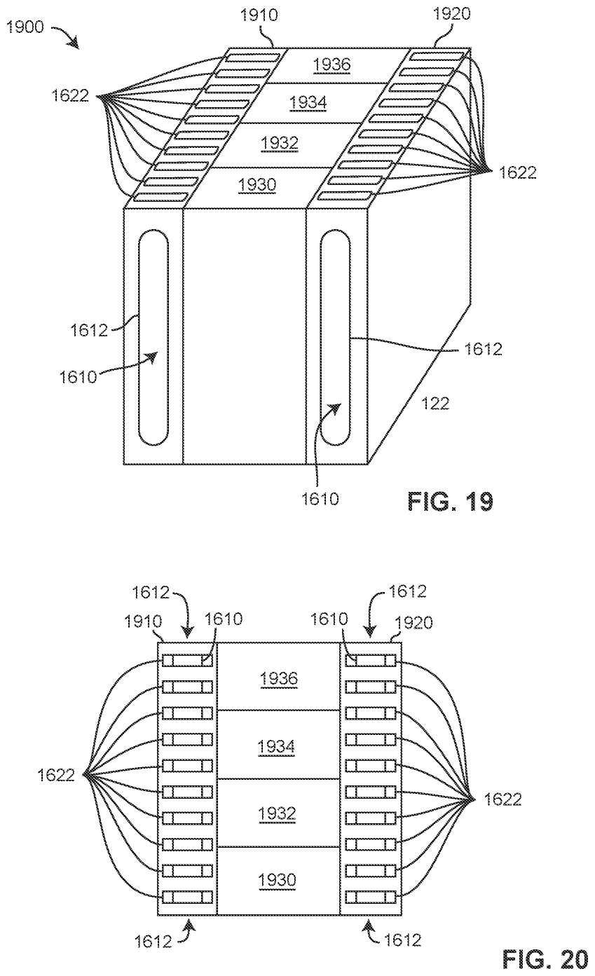

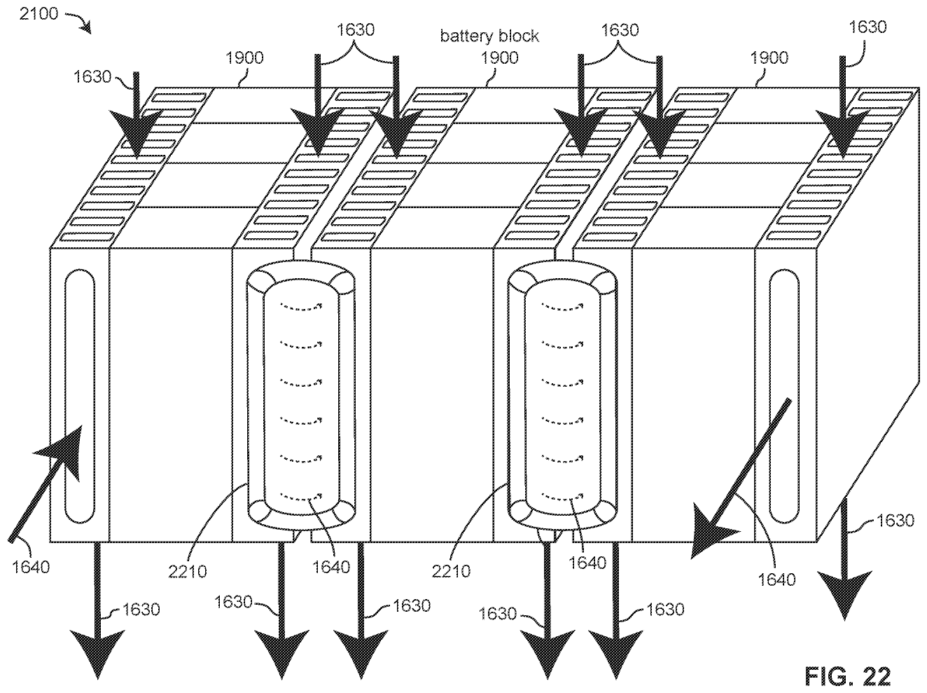

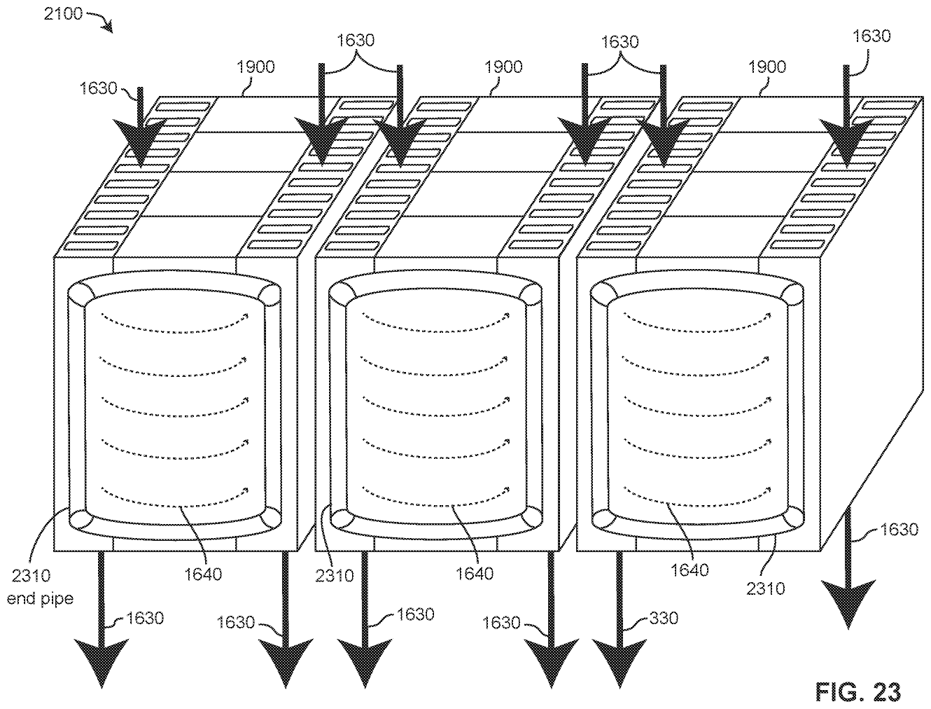

One or more heatsink may be brought into thermal contact with one or more batteries. In an implementation, referring to FIGS. 19-23, a battery block 1900 includes battery cells 1930-1936, a heat sink 1910 and a heat sink 1920. The battery block 1900 may include any number of battery cells, not just the four battery cells shown. The heat sinks 1910 and 1920 are thermally and/or physically coupled to the battery cells 1930-1936. The heat sinks 1910 and 1920 are each a heat sink 1600. A thermal paste may be positioned at the interface between the housing of the battery cells 1930-1936 and the sides 1626 of the heat sinks 1910 and 1920. The medium 1630 may enter the openings 1622 at the top or the bottom of the heat sinks 1910 and 1920, pass through the passage 1620, and exit the bottom or top respectively of the heat sinks 1910 and 1920.

The fins 1624 between the openings 1622 may facilitate heat transfer from the medium 1630 to the heat sink 1600. The fins 1624 increase the surface area of the passage 1620 of the heat sink 1600. The fins 1624 may be of any thickness. Decreasing a thickness of the fins 1624 and increasing their number, increases a surface area of the passage 1620 and thereby improves heat transfer. As the medium 1630 enters or exits the openings 1622, the medium 1630 comes into contact with the fins 1624 thereby promoting heat transfer. The medium 1630 further comes into contact with the sides 1626 to further transfer heat.

The heat sinks 1910 and 1920 further include the openings 1612 and the pipes 1610. The medium 1640 enters and exits the pipes 1610 through the openings 1612. As the medium 1640 flows through the pipe 1610, the medium 1640 comes into contact with an interior surface of the pipe 1610. The pipe 1610 is formed of a thermally conductive material whereby heat from the medium 1640 transfers to or from the thermally conductive material that forms the heatsinks 1910 in 1920 and via the heatsinks to and from the battery cells. The outer surface of the pipe 1610 also comes into contact with the medium 1630 as it flows through the passage 1620. Heat may also transfer between the medium 1630 and the medium 1640 via the pipe 1610.

As discussed above, the passage 1620 may be independent of and separate from the pipe 1610. Accordingly, the medium 1630 that flows through the passages 1620 does not flow through the pipes 1610, and the medium 1640 that flows through the pipes 1610 does not flow through the passages 1620. Because the passages are separate from the pipes, a different type of medium may flow through the passages than flows through the pipes.

In an implementation, a gaseous medium flows through both the passages 1620 and the pipes 1610 of the heat sinks 1910 and 1920. The gas mediums may be the same or different. In another implementation, a liquid medium flows through the passages 1620 while a gaseous medium flows through the pipes 1610. In another implementation, a gaseous medium flows through the passages 1620 while a liquid medium flows through the pipes 1610 of the heat sinks 1910 and 1920. In another implementation, a liquid medium flows through the passages 1620 of the heat sinks 1910 and 1920 while a gaseous medium flows through the pipes 1610 of heat sinks 1910 and 1920.

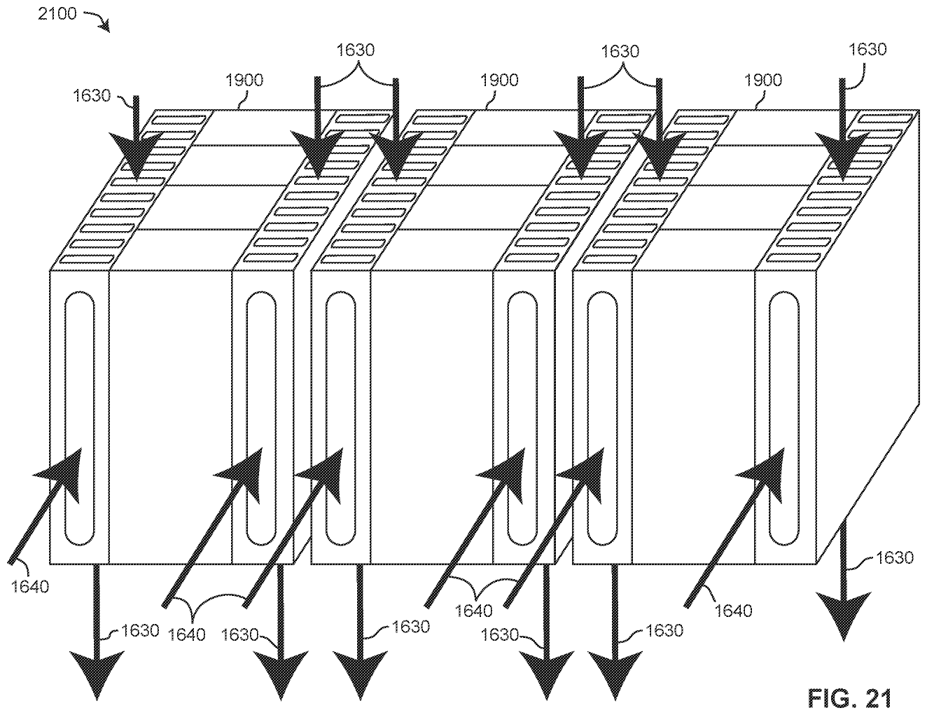

Any number of battery blocks 1900 may be combined with each other to form a battery module 2100. A battery module 2100 may comprise a single battery block. In another implementation, the battery module 2100 includes three battery blocks 1900. Each battery block includes their own heat sinks 1600 as discussed above. The battery blocks may be positioned so that they do not contact each other as shown in FIGS. 21-23 to allow a medium to flow between the battery blocks. In another implementation, some or all of the heat sinks 1600 of a battery block contact (e.g., abut) heatsinks of an adjacent battery block.

In FIG. 21, either medium 1630 or medium 1640 may flow in the spaces between battery blocks. If the flow of the medium 1630 is directed to the openings 1622 such that the medium 1630 can only enter or exit the openings 1622, then the medium 1630 will not flow in the spaces between the battery blocks 1900. If the flow of medium 1640 is directed to the openings 1612 so that the medium 1640 can only enter or exit the openings 1612 of the pipe 1610, then the medium 1640 will not flow in the spaces between the battery blocks 1900. In an implementation, the medium 1630 is a gaseous medium. Physical barriers (e.g., tubes, ducts) seal around the passage 1620 to restrict the flow of the medium 1630 into and out of the openings 1622. In this implementation, the medium 1640 is a liquid medium that may flow not only into the openings 1612 of the pipes 1610, but also in the spaces between the battery blocks 1900. In this implementation, the battery module 2100 may be placed in a bath of the medium 1640 in the environment container 1030. The openings 1622 and the passages 1620 are separate from the environment container 1030 so that no liquid from the bath can enter the opening 1622 to flow through the passage 1620. However, because battery module 2100 is positioned in the bath, the liquid in the bath may flow through pipes 1610 and around battery blocks 1900. In an implementation where the medium 1630 is a gas and the medium 1640 is a liquid, the medium 1640 may be used to deliver heat to a battery cell and the medium 1630 may be used to cool, or extract heat from, the battery cell.

The end pipes 2210 and 2310 may seal around an opening 1612 of one heatsink and around an opening 1612 of another heatsink to direct the flow of the medium 1640 through one pipe 1610, through the end pipe 2210 or 2310, and through another pipe 1610. The end pipes and similar structures may be used to direct the flow of the medium 1630 and/or the medium 1640 to any number of passages 1620 and/or pipes 1610 respectively. As discussed above, the heat sinks 1600, and thereby the battery blocks 1900, may be stacked top-to-bottom and end-to-end to establish a passage 1620 of greater length and a pipe 1610 of greater length respectively.

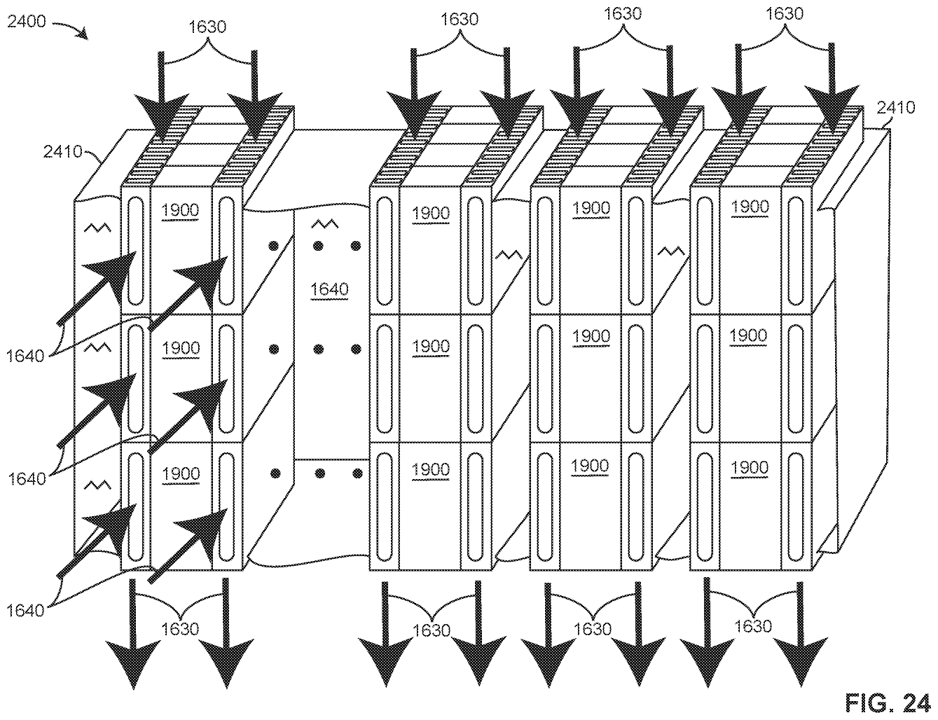

As discussed above, any number of battery blocks 1900 may be combined to form a battery module 2100. Any number of battery modules 2100 may be combined to form a battery pack (e.g., battery pack 1000). A battery pack may be immersed in a liquid in such a manner that the liquid serves the function of the medium 1640 and does not interfere with the passage of the medium 1630 through the passages 1620. For example, in FIG. 24, a plurality of battery blocks is organized as battery modules, which in turn are then organized into the battery pack 2400. The battery pack 2400 is positioned in container 2410 which is similar in function to environment container 1030.

Several blocks 1900 are stacked on top of each other to form battery modules. The interfaces between the passages 1620 of the stacked battery blocks 1900 are sealed to form long passages 1620 from the top of the battery module 2400 to the bottom of the battery module 2400. Battery blocks 1900 could also be stacked end-to-end (e.g., out of the page) to form longer pipes 1610. The container 2410 is sealed around the uppermost and the lowermost battery blocks 1900, such that the liquid medium 1640 is contained in the container 2410, but the passages 1620 are accessible outside of the container 2410. Because the openings 1620 at the top and the bottom of the container 2410 are accessible, the medium 1630, in this implementation in the form of gas, may pass through the passages 1620 without mixing with the medium 1640. The medium 1640, which in this example is a liquid, is contained in the container 2410 so that it may be pumped through pipes 1610 and between battery blocks 1900. The movement and temperature of the medium 1630 and the medium 1640 may be controlled by the central control unit 1010. Because the container 2410 is sealed around the uppermost and the lowermost battery blocks, the medium 1630 may pass through the passages 1620 without mixing with the medium 1640 as it is pumped through the pipes 1610 and between the battery blocks.

In an implementation, the medium 1640 is heated to transfer heat to the battery cells of the battery blocks 1900 and the medium 1630 is cooled, or provided at the temperature of the environment, to cool the battery cells of the battery blocks 1900.

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refers to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A method performed by a charging station for charging a battery to reduce development of a dendrite on a solid electrolyte interface (“SEI”) layer of the battery, the method comprising:
providing a current at a first magnitude and a voltage, until an amount of charge stored by the battery is between 60% and 70% of the storage capacity of the battery, the first magnitude being at least six times a storage capacity of the battery;
after the amount of charge stored by the battery is at least one of 60% and 70% of the storage capacity of the battery, providing the current at a second magnitude, the second magnitude in accordance with an internal resistance of the battery and an output voltage of the battery; and
stopping providing the current when the amount of the charge stored by the battery is 90% of the storage capacity of the battery.

2. The method of claim 1 wherein while providing the current at the first magnitude and the voltage, maintaining a temperature of the battery at between 50° C. and 65° C.

3. The method of claim 1 wherein while providing the current at the first magnitude and the voltage:
increasing the current to a third magnitude for a duration of time;
the third magnitude is at least 10 times the storage capacity of the battery; and
the duration of time is between 10 and 100 ms inclusive.

4. The method of claim 1 wherein while providing the current at the first magnitude and the voltage:
reversing a direction of a flow of the current and increasing the current to a third magnitude for a duration of time, whereby the current flows out of the battery at the third magnitude for the duration of time;
the third magnitude is at least 10 times the storage capacity of the battery; and
the duration of time is between 10 and 100 ms inclusive.

5. The method of claim 1 wherein while providing the current at the first magnitude and the voltage:
for a duration of time, performing at least one of:
increasing the current to a third magnitude; and
reversing a direction of a flow of the current and increasing the current to the third magnitude whereby the current flows out of the battery at the third magnitude;
the third magnitude is at least 10 times the storage capacity of the battery; and
the duration of time is between 10 and 100 ms inclusive.

6. The method of claim 1 wherein while providing the current at the first magnitude and the voltage, maintaining a temperature of the battery at between 50° C. and 65° C.

7. The method of claim 6 while providing the current at the first magnitude and the voltage:
increasing the current to a third magnitude for a duration of time;
the third magnitude is at least 10 times the storage capacity of the battery; and
the duration of time is between 10 and 100 ms inclusive.

8. The method of claim 6 while providing the current at the first magnitude and the voltage:
reversing a direction of a flow of the current and increasing the current to a third magnitude for a duration of time, whereby the current flows out of the battery at the third magnitude for the duration of time;
the third magnitude is at least 10 times the storage capacity of the battery; and
the duration of time is between 10 and 100 ms inclusive.

9. The method of claim 6 while providing the current at the first magnitude and the voltage:
for a duration of time, performing at least one of:
increasing the current to a third magnitude; and
reversing a direction of a flow of the current and increasing the current to the third magnitude whereby the current flows out of the battery at the third magnitude;
the third magnitude is at least 10 times the storage capacity of the battery; and
the duration of time is between 10 and 100 ms inclusive.

10. The method of claim 1 wherein the second magnitude of the current is equal to (Vinput−Vcell)/Rcell where Vinput is equal to the voltage, Vcell is equal to the output voltage of the battery, and Rcell is equal to the internal resistance of the battery.

11. A method performed by a charging station for charging a battery to reduce development of a dendrite on a solid electrolyte interface (“SEI”) layer of the battery, the method comprising:
providing a current at a first magnitude and a voltage until an amount of charge stored by the battery is between 60% and 70% of the storage capacity of the battery, the first magnitude being at least six times a storage capacity of the battery;
for a duration of time, performing at least one of:
increasing the current to a second magnitude; and
reversing a direction of a flow of the current and increasing the current to the second magnitude whereby the current flows out of the battery at the second magnitude, wherein the second magnitude is at least 10 times the storage capacity of the battery, and the duration of time is between 10 and 100 ms inclusive;
stopping providing the current when the amount of charge stored by the battery is 90% of the storage capacity of the battery.

12. The method of claim 11 wherein while providing the current, maintaining a temperature of the battery at between 50° C. and 65° C.

13. The method of claim 11 wherein the current at the second magnitude provides at least 12 mA h/cm\hat{ }2 across an area of the SEI layer.

14. A method performed by a charging station for charging a battery to reduce development of dendrites on a solid electrolyte interface (“SEI”) layer of the battery, the method comprising:
providing a current at a first magnitude and a voltage, the first magnitude being at least six times a storage capacity of the battery;
during a first duration of time, providing the current at a second magnitude, the second magnitude greater than the first magnitude, the current at the second magnitude provides at least 12 mA h/cm\hat{ }2 across an area of the SEI layer in a first direction;
during a second duration of time, reversing a direction of the current to draw the current at a third magnitude from the battery, the current at the third magnitude provides at least 12 mA h/cm\hat{ }2 across the area of the SEI layer in a second direction, the second direction opposite the first direction; wherein:
the first duration of time and the second duration of time are between 10 and 100 ms inclusive.

15. The method of claim 14 wherein maintaining a temperature of the battery at between 50° C. and 65° C.

16. The method of claim 14 wherein the second magnitude and the third magnitude are at least 10 times the storage capacity of the battery.

17. The method of claim 14 wherein repeating providing the current at the first magnitude and the first voltage, providing the current at the second magnitude and reversing the direction of the current until an amount of charge stored by the battery is between 60% and 70% of the storage capacity of the battery.

18. The method of claim 14 wherein ceasing providing the current at the first magnitude and the first voltage, providing the current at the second magnitude and reversing the direction of the current after an amount of charge stored by the battery is 90% of a storage capacity of the battery.
